(19) United States
(12) Patent Application Publication
(10) Pub. No.: US 2026/0140239 A1
(43) Pub. Date: May 21, 2026

(54) DEVICE AND METHOD FOR ENCODING AND CAPTURING SIGNAL SHAPE INFORMATION

(71) Applicant: OSRAM GmbH, Muenchen (DE)

(72) Inventors: Florian Kolb, Jena (DE); Gerhard Maierbacher, Poing (DE)

(21) Appl. No.: 19/120,173

(22) PCT Filed: Oct. 17, 2023
(86) PCT No.: PCT/EP2023/078843

§ 371 Date: Apr. 10, 2025

(30) Foreign Application Priority Data
Oct. 17, 2022 (DE) 10 2022 127 081.5

(51) Int. Cl. G01S 7/4865

(52) U.S. Cl. CPC G01S 7/4865

(57) ABSTRACT

In an embodiment a detection device includes a processing circuit configured to receive a detection signal representative of a receive signal detected at the detection device, wherein the receive signal is associated with a corresponding predefined transmit signal and/or is associated with one or more expected signal features, to generate a differentiation signal representative of a rate of change of a signal level of the detection signal over time, to determine time points corresponding to a change of a sign of the differentiation signal and to encode the determined time points to generate an output signal representative of one or more characteristic properties of the receive signal.

### CROSS-REFERENCE TO RELATED APPLICATIONS

This patent application is a national phase filing under section 371 of PCT/EP 2023/078843, filed Oct. 17, 2023, which claims the priority of German patent application no. 10 2022 127 081.5, filed Oct. 17, 2022, each of which is incorporated herein by reference in its entirety.

### TECHNICAL FIELD

Various aspects are related to a detection device adapted to detect and reconstruct a signal, and methods thereof (e.g., a method of carrying out signal detection and reconstruction).

### BACKGROUND

In general, direct time-of-flight (ToF) systems measure the distance between a detector and an object based on the time difference between the emission of a light pulse and the return of its echo(s) to the detector. Direct time-of-flight systems are frequently implemented adopting a time-to-digital converter (TDC) based approach providing a digital representation of the time between the emission of a light pulse (associated with a start signal) and the detection of its echo (associated with a stop signal). Due to the simplicity of this approach, TDC-based systems usually do not provide information about the shape (or the amplitude) of the received pulse. However, this information would be advantageous to improve the detector performance and open up new functionalities.

Full-waveform sampling solutions exist to determine the amplitude and pulse shape information, mostly in the LIDAR (Light Detection and Ranging) domain, which however usually require a high-speed analog-to-digital converter (ADC) as well as a powerful processing stage, both of which are costly and lead to a high-power consumption, thus making this option prohibitive for mobile devices and/or consumer market applications. An exemplary approach includes a plurality of N comparators each associated with an independent TDC stage, which however leads to a significant number of hardware components (illustratively, the higher the number of comparators is, the larger will be the number of TDCs).

### SUMMARY

Embodiments provide an enhanced signal processing scheme based on analyzing the rate of change over time of a detected signal to derive in a simple, yet accurate manner relevant signal information (e.g., shape information, amplitude information), which would otherwise be lost in a conventional TDC-approach. The analysis of the rate of change over time may provide an efficient encoding scheme for identifying and characterizing relevant portions of the detected signal, without having to rely on complex and costly hardware components.

According to various embodiments, the enhanced signal capturing scheme may be based on derivatives (e.g., first-order and/or second-order derivatives) of the detected signal. This has the advantage that important information about the pulse shape, such as the number and the position of peak(s) in the echo, which are of the highest interest, are captured more accurately and encoded more efficiently. Furthermore, as information about the derivatives is handled on its own, this gives easier access to the relevant information about the pulse shape (e.g., the number and the position of the peaks), and thus allows to further minimize the required signal processing. The configuration described herein allows simplifying the overall structure of the detection device, and to use overall fewer components with respect to a conventional approach for full-waveform sampling.

As examples, in the context of time-of-flight measurements, the additional information may be advantageous for estimating the reflectance or other surface properties of an object (e.g., by measuring or estimating the pulse amplitude). The additional information may be further used for the detection of multiple echoes to distinguish between objects at different distances within the field of view (e.g., including transparent objects like glass with partial reflections). As another example, the additional information may be used for signal averaging and advanced signal processing purposes, such as to compensate for the walk error (e.g., by relying on the peak of the echo), for interfering signal detection and crosstalk rejection (e.g., using pulse shape identification/recognition, or correlation receiver concepts), or for other subsequent processing steps like object detection, object tracking, and sensor fusion stages (e.g. benefitting from object edge detection, or the detection of the object's tilt, both of which may be inferred by the received signal pulse shape).

The present disclosure may thus be based on the realization that the analysis of the rate of change over time of a detected signal provides a direct and resource-efficient way of deriving or estimating various signal properties, e.g. in the context of TDC-based detection, which properties may then be used for more advanced processing purposes.

The most relevant use case for the approach described herein may be for time-of-flight systems, e.g. in the context of LIDAR detection, since the analysis of the rate of change may be readily integrated into a time-of-flight detector or LIDAR device, without having to modify the underlying circuitry. Furthermore, the signal reconstruction capabilities may augment the time-of-flight detection, by providing information on signal properties that would otherwise not be derivable with a simple direct time-of-flight detector. Therefore, in the following, some embodiments are described with particular focus on time-of-flight detection and LIDAR devices. However, the approach described herein is not limited to time-of-flight or LIDAR applications, but may be in general implemented in any scenario where a temporal signal is digitized for processing. Other exemplary fields of application may include RADAR detectors, sound waves-based detectors, movement trackers, and the like.

In general, the present disclosure is related to an adapted processing scheme for processing a detected signal. The type of signal that is detected may vary, as long as the signal is provided into a form that allows the processing described herein. Various embodiments described in the following make particular reference to light signals (e.g., for time-of-flight or LIDAR applications), but it is understood that the adapted signal processing may in principle be applied to other types of signals, such as radio waves, audio signals, position tracking, etc., with an adaptation of how the signal is originally detected and generated.

According to various embodiments, a detection device may include: a processing circuit configured to: receive a detection signal representative of a receive signal detected at the detection device, wherein the receive signal is associated with a corresponding predefined transmit signal and/or is associated with one or more expected signal features; generate a differentiation signal representative of a rate of change of a signal level of the detection signal over time; determine time points corresponding to a change of a sign of the differentiation signal; and encode the determined time points to generate an output signal representative of one or more characteristic properties of the receive signal detected at the detection device.

According to various embodiments, a detection device may include: a processing circuit configured to: receive a detection signal representative of a receive signal detected at the detection device, wherein the receive signal is associated with a corresponding predefined transmit signal; generate a differentiation signal representative of a rate of change of a signal level of the detection signal over time; determine time points corresponding to a change of a sign of the differentiation signal; and encode the determined time points to generate an output signal representative of one or more characteristic properties of the receive signal detected at the detection device.

According to various embodiments, a detection device may include: a processing circuit configured to: receive a detection signal representative of a receive signal detected at the detection device; generate a differentiation signal representative of a rate of change of a signal level of the detection signal over time; determine time points corresponding to a change of a sign of the differentiation signal; and encode the determined time points to generate an output signal representative of one or more characteristic properties of the receive signal detected at the detection device.

The present disclosure may be based on the realization that time points at which the differentiation signal changes its sign may correspond to time locations within the detection signal of one or more characteristic portions of the detection signal (e.g., peaks, valleys), so that identifying such time points may provide a direct, yet reliable approximation of a waveform of the detection signal (and accordingly of the signal detected at the detection device), which may then allow to infer or estimate various properties of the signal.

According to various embodiments, a method of carrying out signal detection may include: generating a differentiation signal representative of a rate of change of a signal level of a detection signal over time, wherein the detection signal is representative of a detected receive signal, wherein the receive signal is associated with a corresponding predefined transmit signal and/or is associated with one or more expected signal features; determining time points corresponding to a change of a sign of the differentiation signal; and encoding the determined time points to generate an output signal representative of one or more characteristic properties of the detected receive signal.

The approach described herein may thus be based on characterizing a signal detected at a detection device in a simple manner by analyzing the rate of change of the signal level over time, and on combining the obtained information with an “a priori” knowledge of expected features or properties of the detected signal to carry out a simple, yet accurate reconstruction of the signal waveform and to enable further processing.

In a preferred configuration, the processing circuit may be configured to differentiate the detection signal in an analog manner (illustratively, by means of an analog differentiator). The use of an analog differentiator to generate a signal representative of the rate of the change provides a simple implementation that allows operating the detection device without the need for expensive high-speed analog-to-digital converters for sampling the signal. The analog implementation may be particularly advantageous in the context of TDC-based detection, e.g. for direct time-of-flight measurements, since it allows maintaining an overall cost-efficient configuration for the detector.

According to various embodiments, the processing circuit may be further configured to determine (e.g., to calculate, or to measure) a time-of-flight associated with the receive signal, e.g. based on a knowledge of an emission time point of a corresponding transmit signal. The processing circuit may be configured to use the additional information obtained by analyzing the rate of change of the detected signal to refine the time-of-flight measurement, e.g. to adjust the determined value, to remove interferences, and the like. The approach described herein may thus provide an efficient way of gaining information that may be used to adjust a time-of-flight measurement, e.g. a TDC-based direct time-of-flight measurement.

According to various embodiments, a time-of-flight detector may include: a processing circuit configured to: receive a start signal representative of a starting time point of an emission of a transmit signal; receive a detection signal representative of a receive signal detected at the time-of-flight detector, wherein the receive signal includes a (direct) reflection of the transmit signal towards the time-of-flight detector; generate a stop signal representative of an arrival time of the receive signal at the time-of-flight detector; carry out a time-to-digital conversion to calculate a time-of-flight associated with the transmit signal based on the start signal and the stop signal; generate a differentiation signal representative of a rate of change of a signal level of the detection signal over time; determine time points corresponding to a change of a sign of the differentiation signal; and modify a value of the calculated time-of-flight based on the determined time points.

As mentioned above, conventional implementations try to capture the pulse shape using an array of comparators in conjunction with a TDC, and then derive information about pulse characteristics from the captured temporal pulse shape, e.g. by “fitting” a mathematical representation of the expected pulse shape to the acquired data. An example of this approach is described in DE 10 2021 101 790 A1. In many cases, however, only certain embodiments of the pulse shape are of importance, e.g. the peak of the pulse or other characteristic points. The present disclosure may thus be based on the realization that it is not necessary to acquire the complete pulse shape data, but a direct acquisition of only the timing of these characteristic points not only increases the accuracy but also greatly simplifies the post-processing of the data, and such direct acquisition may be implemented in a simple manner by determining the rate of change over time of the detected signal. Illustratively, for signal reconstruction purposes (and for time-of-flight measurement) it may suffice to identify the peaks of the detected signal, without the need for sampling every point of the signal waveform as in a conventional approach.

The strategy described herein may be based on transforming (analog) detected signals prior to encoding. In some embodiments, the processing circuit may be configured to derive (or approximate) derivatives of the detected signal and use them as a more adequate representation and as a basis for subsequent signal encoding steps. For example, the processing circuit may be configured to use the first and/or the second derivative as a basis for signal encoding. Depending on the objective of the implementation the first and/or the second derivative may be selected, such that the relevant information about the pulse shape may be efficiently captured. As an example, in case the number and position of the peak(s) in the echo is of highest relevance, then the first derivative may be determined, and the processing circuit may search for the zero-crossings in the signal. Since the derivatives may be encoded on their own, the approach described herein provides easier access to the relevant information, and thus allows to minimize the required signal processing that usually follows the signal capturing process.

The derivative-based strategy provides thus simple means to capture pulse shape information, which may provide improving the overall performance of the detection device, e.g. to compensate for the walk error, and improve time-of-flight measurement accuracy. The additional information may open up new functionalities, e.g. providing information about the detected object from the pulse shape, being able to distinguish objects, edge detection becomes possible, etc. Furthermore, the overall detection device may maintain the advantages of a TDC-based approach, such as a simple system setup that reduces the number of expensive components while being suitable for high-speed implementations. Compared to full-waveform sampling solutions, no high-speed ADC is needed, which is beneficial with respect to power consumption and cost. Finally, in light of the event-based nature of TDC detection schemes, the amount of generated data is relatively small. This means that there is less data to process (e.g., less CPU load is generated) and hence less CPU-power is needed, thus reducing power consumption and cost of the system.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. In the following description, various embodiments are described with reference to the following drawings, in which:

FIG. 1A to FIG. 1C each shows a detection device in a schematic view according to various embodiments;

FIG. 2A to FIG. 2F illustrate various embodiments of the operation and of the configuration of a processing circuit of a detection device in a schematic view, according to various embodiments;

FIG. 3 shows a series of graphs illustrating an exemplary operation of a detection device and of a processing circuit of the detection device, according to various embodiments;

FIG. 4A and FIG. 4B each shows a detection device in a schematic view, according to various embodiments;

FIG. 5A and FIG. 5B each shows an analog portion of the processing circuit of a detection device in a schematic view, according to various embodiments;

FIG. 5C to FIG. 5G illustrate various embodiments of the operation of the processing circuit of a detection device, according to various embodiments;

FIG. 6 shows a time-to-digital converter circuit in a schematic view, according to various embodiments; and

FIG. 7 shows a LIDAR system including a detection device, according to various embodiments.

### DETAILED DESCRIPTION OF ILLUSTRATIVE EMBODIMENTS

The following detailed description refers to the accompanying drawings that show, by way of illustration, specific details and implementations in which the embodiments disclosed herein may be practiced. These embodiments are described in sufficient detail to enable those skilled in the art to practice the disclosed implementations. Other embodiments may be utilized and structural, logical, and electrical changes may be made without departing from the scope of the disclosed implementations. The various embodiments are not necessarily mutually exclusive, as some embodiments may be combined with one or more other embodiments to form new embodiments. Various embodiments are described in connection with methods and various embodiments are described in connection with devices (e.g., a detection device, a processing circuit, a time-of-flight detector, etc.). However, it is understood that embodiments described in connection with methods may similarly apply to the devices, and vice versa.

The figures include various graphs representing various signals and waveforms. It is understood that the signals and waveforms illustrated in the figures are for explanation purposes, and the various signals and waveforms may vary depending on the type of application, the type of signal, an environmental scenario, etc.

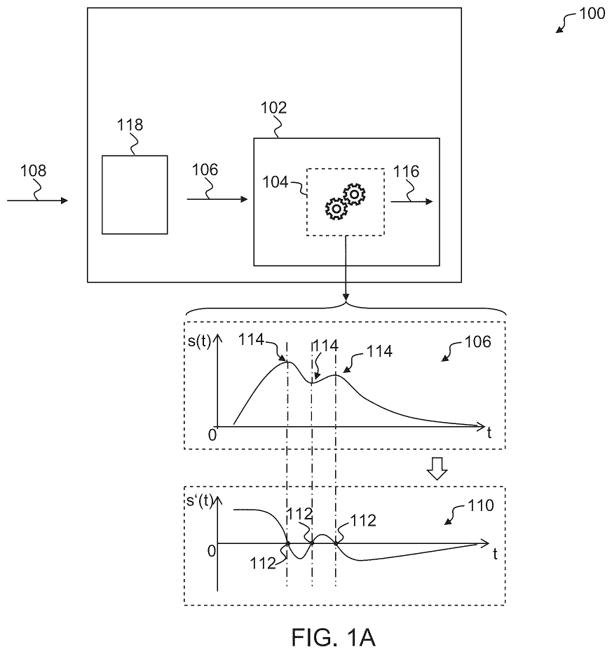

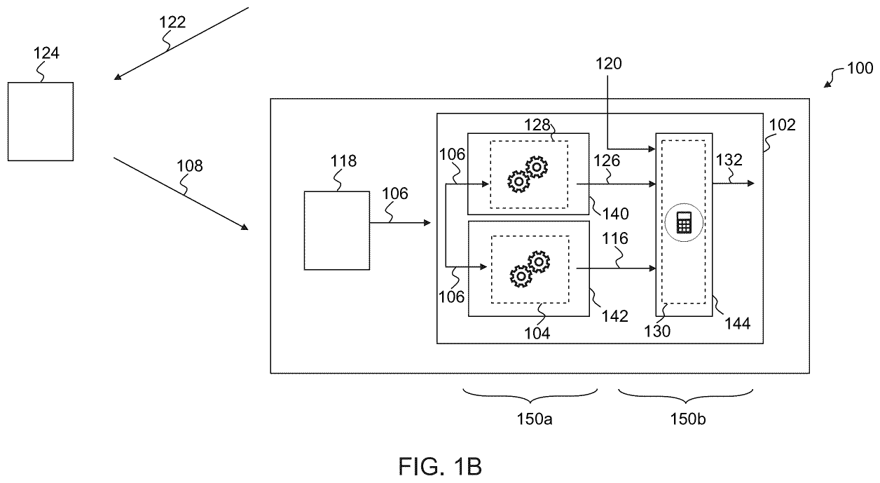

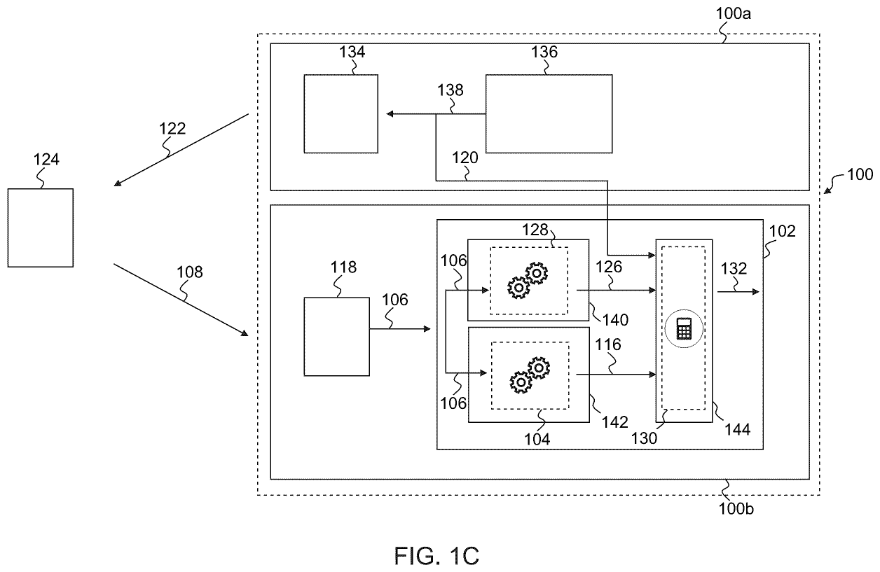

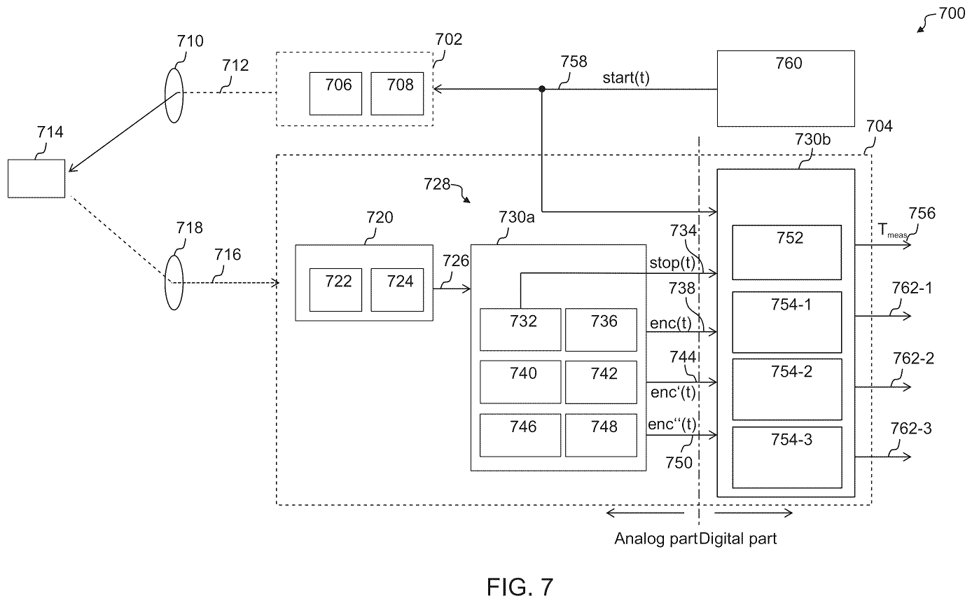

FIG. 1A shows a detection device 100 in a schematic view according to various embodiments. The detection device 100 may in general be configured to carry out detection and processing of a temporal signal, e.g. may be configured to digitize a temporal signal and carry out digital processing of the digitized signal. In a preferred configuration, the detection device 100 may be a time-of-flight detector (see also FIG. 1B and FIG. 1C), e.g. for use in a LIDAR system (see FIG. 7). In an exemplary application scenario, the detection device 100 may be integrated in a vehicle (e.g., a vehicle capable of at least partially autonomous driving, for example an electric car), or in an indoor monitoring system.

The detection device 100 may include a processing circuit 102 configured to carry out the adapted signal processing described herein. Illustratively, the processing circuit 102 may be configured to carry out an adapted method 104 of signal detection and processing. Various references herein to the operation of the processing circuit 102 may be understood as corresponding method steps of the method 104, and vice versa.

The processing circuit 102 may be configured to receive a detection signal 106 s(t) representative of a signal 108 detected at the detection device 100. The detection signal 106 may reproduce the signal 108 received at the detection device 100 in a format that allows processing by the processing circuit 102. In general, the detection signal 106 may be a digital signal or an analog signal, depending on the configuration of the processing circuit 102. In a preferred configuration, the detection signal 106 processed by the processing circuit 102 may be an analog signal (e.g., a voltage, or a current, encoding information in an analog manner) to allow for a simpler implementation of the processing circuit 102. The signal 108 detected at the detection device 100 may also be referred to herein as receive signal, received signal, or detected signal. In the following, references to properties of the detection signal 106 (e.g., in terms of waveform, signal level, etc.) may apply in a corresponding manner to the receive signal 108 that the detection signal 106 represents, and vice versa.

According to various embodiments, the detection device 100 may include a detector 118 configured to detect the receive signal 108 and generate a corresponding detection signal 106. The detector 118 may be coupled with the processing circuit 102 and may be configured to deliver the detection signal 106 to the processing circuit 102. In general, the detector 118 may be configured to be sensitive for a type of energy of interest, e.g. a type of radiation of interest, such as light, sound, radio, etc. The configuration of the detector 110 may be adapted according to the desired application. In the context of the present disclosure, the term “detector” may be used in a same manner as the term “sensor”.

For example, e.g. in the context of ToF-measurements and LIDAR, the detector 118 may be a light detector configured to detect light (e.g., the detector 118 may include one or more photo diodes, a transimpedance amplifier, and the like), and the signal 108 may be a light signal. As another example, the detector 118 may be a radio receiver configured to capture radio waves (e.g., the detector 118 may include one or more antennas, frequency converters, and the like), and the signal 108 may be a radio signal. As a further example, the detector 118 may be an ultrasound detector configured to capture sound waves (e.g., the detector 118 may include a membrane, a transducer element, and the like), and the signal 108 may be a sound wave.

The detection signal 106 may thus include the radiation captured at the detector 118, e.g. during a predefined detection period. As an example, for light detection, the detection signal 106 may include photon counts over an integration time of the detector 118. The receive signal 108 may thus include a noise component and a signal component. The noise component may include noise from external sources, such as ambient light in the context of light detection.

In various embodiments, the processing circuit 102 may be configured to filter the detection signal 106 prior to further processing (e.g., prior to generating a differentiation signal 110), to reduce a noise level in the detection signal 106 as delivered by the detector 118. Illustratively, the processing circuit 102 may include a filtering circuit configured to receive an input signal (the detection signal 106) and output a filtered signal corresponding to a noise-filtered version of the input signal. As an exemplary configuration, the processing circuit 102 may include a low-pass filter configured to filter out components of the detection signal 106 having a frequency greater than a predefined threshold frequency, or a high-pass filter configured to filter out components of the detection signal 106 having a frequency less than a predefined threshold frequency. As another exemplary configuration, the processing circuit 102 may include a band-pass filter configured to filter out components of the detection signal having a frequency outside of a predefined frequency range. The threshold frequency and/or frequency range may be adapted according to an expected frequency of the noise component and/or signal component of the receive signal 108, to let the signal component pass through and filter out the noise component. In a preferred configuration, the filtering circuit may be an analog circuit.

The processing circuit 102 may be configured to generate a differentiation signal 110 s′(t) representative of a rate of change of a signal level of the detection signal 106 over time. The processing circuit 102 may be configured to carry out a differentiation of the detection signal 106 (in some embodiments, a differentiation of a filtered version of the detection signal 106) to obtain, as result of the processing, the differentiation signal 110. The signal level of the differentiation signal 110 may thus vary over time according to the rate of change of the signal level of the detection signal 106. Illustratively, a signal level of the differentiation signal 110 at a certain time point may correspond to a value of the rate of change of the signal level of the detection signal 106 at that time point. Considering an analog implementation, the differentiation signal 110 may be an analog signal.

The expression “signal level” may be used herein to describe a parameter associated with a signal (e.g., with a detection signal, a differentiation signal, etc.) or with a portion of a signal (e.g., with a peak or a valley). A “signal level” as used herein may include at least one of a power level, a current level, a voltage level, or an amplitude level (also referred to herein as amplitude). In a preferred configuration for an analog implementation of the operation of the processing circuit, a signal level of a signal may be expressed as a voltage level during processing. In general, a “signal level” may represent a magnitude of the corresponding signal, e.g. over time or at a certain time point. A “signal level” may have, in some embodiments, a magnitude and a sign (positive or negative), depending on the type of signal, on the representation of the signal, etc.

The processing circuit 102 may be further configured to determine (e.g., identify) time points 112 corresponding to a change of a sign of the differentiation signal 110, e.g. from positive to negative or from negative to positive. The processing circuit 102 may thus be configured to determine whether and where the differentiation signal 110 changes its sign. Illustratively, the processing circuit 102 may be configured to determine time points 112 at which the signal level of the differentiation signal 110 becomes zero, e.g. from being positive to zero prior to becoming negative, or from being negative to zero prior to becoming positive. A change of sign in the differentiation signal 110 may correspond to a variation in the behavior of the detection signal 106, e.g. from a signal level that is increasing over time to a signal level that is decreasing over time, or vice versa.

The time points 112 corresponding to a change of a sign of the differentiation signal 110 may correspond to respective time locations within the detection signal 106 of one or more characteristic portions 114 of the detection signal 106. The characteristic portions 114 of the detection signal 106 may include, as examples, one or more peaks and/or one or more valleys. Illustratively, a time point 112 corresponding to a sign change of the differentiation signal 110 may match a time point at which the detection signal 106 (and accordingly the receive signal 108) has a peak or a valley, as an example. The processing circuit 102 may thus be configured to determine (e.g., identify) a respective time location of the characteristic portions of the detection signal 106 based on the determined time points 112. The characteristic portions of the detection signal 106 may correspond to respective characteristic portions of the receive signal 108.

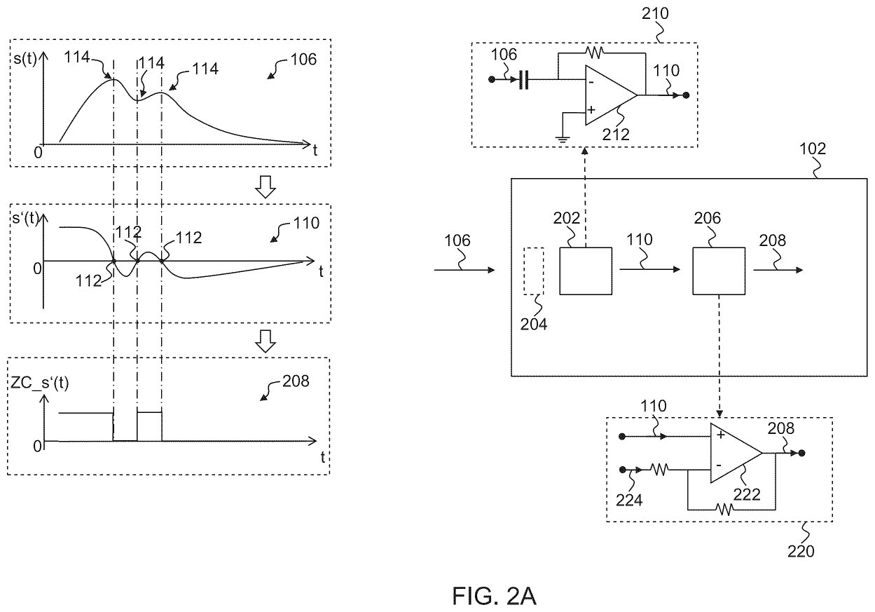

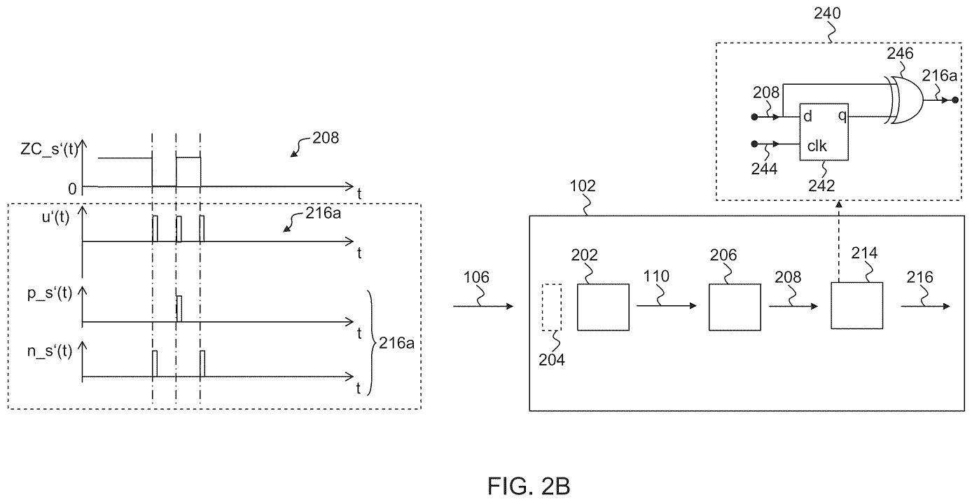

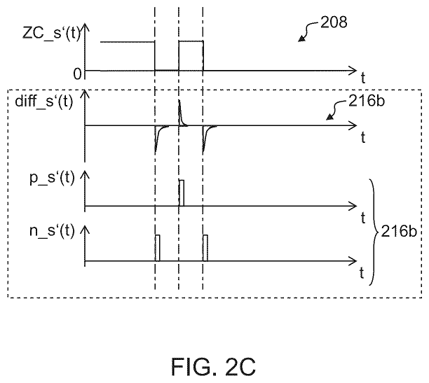

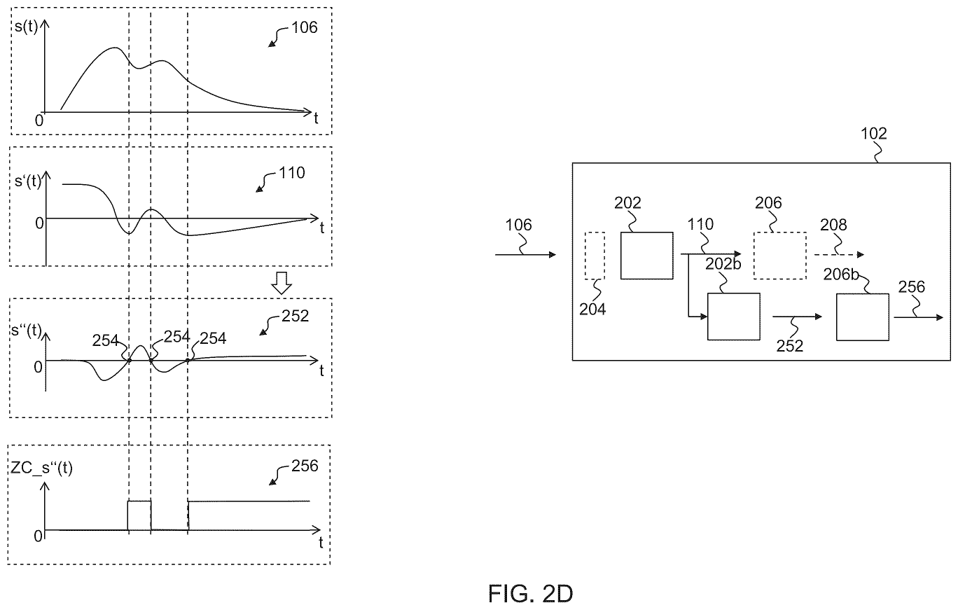

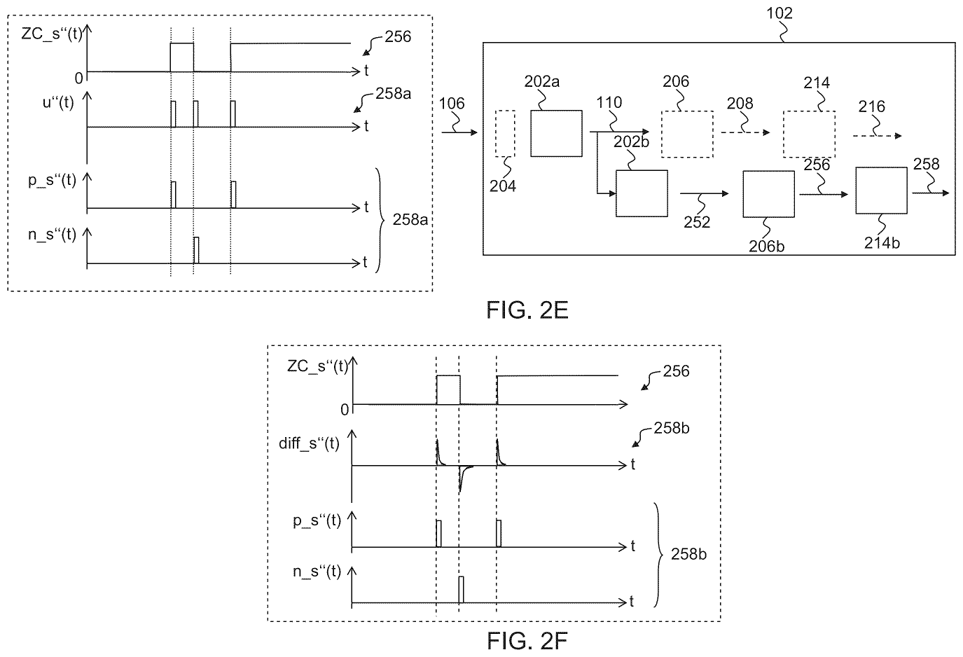

The present disclosure may be based on the realization that the information provided by identifying the sign changes of the differentiation signal 110 sufficiently characterizes the detected signal 108 to allow for a more advanced and more refined processing, and may be obtained with a simple and readily available circuit configuration (see for example FIG. 2A). Illustratively, finding the “zero-crossing” time points 112 in the differentiation signal 110 allows approximating the temporal evolution of the detection signal 106 (and accordingly of the receive signal 108) in a simple, yet sufficiently accurate manner for carrying out further processing and refinement of other measurements (e.g., of a time-of-flight measurement, as discussed in relation to FIG. 1B and FIG. 1C).

In various embodiments, the processing circuit 102 may be configured to generate an output signal 116 representative of the determined time points 112. The processing circuit 102 may thus be configured to encode the determined time points 112 to generate the output signal 116 representative of one or more characteristic properties of the receive signal 108.

The processing circuit 102 may use the output signal 116 for further processing, and/or may be configured to deliver the output signal to other processing circuits external to the detection device 100. The output signal 116 may thus encode information representative of the moments in time at which a sign change of the differentiation signal 110 occurs, and accordingly may encode information representative of the moments in time at which the detection signal 106 has a characteristic portion (illustratively, a characteristic element, or feature). The processing circuit 102 may be configured to provide the output signal 116 in various forms, as discussed in further detail in relation to FIG. 2A to FIG. 2F. The output signal 116 may also be referred to as encoded differentiation signal.

According to various embodiments, the processing circuit 102 may be configured to store the output signal 116, e.g. in a memory of the processing circuit 102 (e.g., a buffer) and retrieve the stored output signal 116 during a subsequent processing. In this scenario, the processing circuit 102 may be configured to convert the output signal 116 in any suitable format for storing and subsequent retrieval, e.g. via a digital-to-analog converter, as an example.

In general, the type of signal processing described in relation to FIG. 1A may be carried out for any signal that may be detected at the detection device 100. In various embodiments, however, the receive signal 108 may be associated with a corresponding transmit signal 122, whose properties may be known to the processing circuit 102. As an additional or alternative example, the receive signal 108 may have or may be associated with one or more expected signal features. Illustratively, the processing circuit 102 may have an a priori knowledge of features and/or properties of the receive signal 108, such as an expected waveform, an expected number of peaks, and the like.

In an exemplary configuration, as shown in FIG. 1B and FIG. 1C, the receive signal 108 may be or include a reflection of the transmit signal 122 towards the detection device 100. The transmit signal 122 may hit an object 124 (or a plurality of objects) in a field of view of the detection device 100, and the receive signal 108 may be or include a reflection (e.g., a specular reflection, also referred to as direct reflection) from the object 124 towards the detection device 100. It is however understood that, more in general, the receive signal 108 may be understood as the transmit signal 122 as received at the detection device after propagation in a medium (e.g., in air, in a liquid, etc.), so that the original properties of the transmit signal 122 may vary due to the propagation conditions (e.g., obstacles, a viscosity of the medium, a reflectivity of objects encountered, etc.). The receive signal 108 may thus correspond to the associated transmit signal 122 after propagation, and in a relevant use case after reflection.

According to various embodiments, the processing circuit 102 may be configured to carry out a reconstruction of the signal 108 detected at the detection device 100 based on the determined time points 112, illustratively based on the determined time locations of the characteristic portions 114. The processing circuit 102 may be configured to carry out the reconstruction of the receive signal 108 further based on one or more predefined properties of the corresponding transmit signal 122. Illustratively, the processing circuit 102 may be configured to determine one or more properties of the receive signal 108 based on the time points 112 and one or more expected properties for the receive signal 108 according to the (original) properties of the corresponding transmit signal 122 (and/or according to the expected signal features). Further signals and/or properties that the processing circuit 102 may use for the reconstruction will be described in relation to FIG. 2A to FIG. 5G. Stated in a different fashion, the processing circuit 102 may be configured to generate a reconstructed signal representative of the receive signal 108 by using the determined time locations and using one or more predefined (illustratively pre-established) properties of the corresponding transmit signal 122.

As an example, the one or more predefined (illustratively, known to the processing circuit 102) properties of the transmit signal 122 may include a number of peaks in the transmit signal 122, a signal level of the transmit signal 122, a signal level at the peaks of the transmit signal, a time-distance between consecutive peaks in the transmit signal 122, a duration of a peak (e.g., FWHM of the peak), and/or a total duration of the transmit signal 122. In the context of time-of-flight detection using light, the peak(s) in the transmit signal 122 may correspond to light pulse(s) in the transmit signal 122.

As a further example, the one or more characteristic properties of the receive signal 108 that the processing circuit 102 may determine based on the time points 112 may include: a number of peaks in the receive signal 108, a number of valleys in the receive signal 108, a time-distance between consecutive peaks in the receive signal 108, a slope of the receive signal 108, a time-distance between a reference time point (e.g., a starting time point of an emission of the transmit signal 122) and one or more peaks and/or valleys in the receive signal 108.

In general, the transmit signal 122 may include one or more peaks, e.g. a single peak in a simple configuration or a plurality of peaks in a more advanced encoding scheme. With this configuration, it may be assumed that the first time point 112 (illustratively, the time point 112 occurring earliest in time within the differentiation signal 110) may correspond to a first peak in the detection signal 106, i.e. it may be assumed that the first detectable variation in the rate of change over time will occur at the first peak. In this scenario, the subsequent time point 112 (if present) may correspond to a valley, the further subsequent time point 112 (if present) may correspond to a second peak, and so on. In various embodiments, the processing circuit 102 may be configured to associate time points 112 at an odd position in the sequence of time points 112 with a peak of the detection signal 106, and time points at an even position with a valley of the detection signal 106. The number of “odd” time points 112 may thus be indicative of a number of peaks in the detection signal, and a number of “even” time points 112 may be indicative of a number of valleys. Accordingly, a time difference between odd time points 112 may represent a time difference between peaks of the detection signal 106.

According to various embodiments, the processing circuit 102 may be configured to reconstruct the receive signal 108 based on one or more predefined time points of one or more predefined receive signals, e.g. based on one or more predefined characteristic portions of one or more predefined receive signals. Illustratively, the processing circuit 102 may be configured to reconstruct the signal 108 using one or more predefined (e.g., known) patterns for the time location of the characteristic portions. For example, based on a current environmental scenario (e.g., weather conditions, number of obstacles in the field of view, illumination conditions, and the like), the processing circuit 102 may estimate a modification of the transmit signal 122 during propagation, and may thus estimate expected properties or features (e.g., shape, signal level, etc.) of the receive signal 108 to use for the reconstruction. As an example, in the context of light detection in a field of view densely populated with objects, the receive signal 108 will likely have a plurality of peaks corresponding to reflections from multiple objects.

As an exemplary configuration, the processing circuit 102 may be configured to carry out the reconstruction of the receive signal 108 by comparing the determined time points 112 with the predefined time points of the predefined receive signals. The processing circuit 102 may be configured to compare the pattern defined by the determined time points 112 (e.g., a number of time points 112, a time distance between consecutive time points 112, and the like) with one or more predefined (e.g., expected) patterns, and may be configured to reconstruct the receive signal 108 according to the result of the comparison. Illustratively, the receive signal 108 may approximately correspond to the predefined receive signal having the most similar pattern.

In an exemplary configuration, the reconstruction of the receive signal 108 may be carried out in the digital domain. For example, the processing circuit 102 may include an analog portion configured to carry out the initial reception of the detection signal 106, generation of the differentiation signal 110, and identification of time points 112. The processing circuit 102 may further include a digital portion (illustratively, a digital signal processing circuit) configured to receive the information extracted by the analog circuit (encoded in the output signal 116), and configured to carry out the reconstruction of the receive signal 108 based on such additional information.

As mentioned above, relevant use case of the approach described herein may be for time-of-flight measurements. As shown in FIG. 1B, the processing circuit 102 may be further configured to carry out a direct time-of-flight measurement, and may be configured to modify a result of the time-of-flight measurement based on the determined time points 112 (illustratively, using the information encoded in the output signal 116). In this configuration, the processing circuit may be configured to receive a start signal 120 representative of an emission of the transmit signal 122. Illustratively, the start signal 120 may represent or indicate a starting time point of the emission of the transmit signal 122. The start signal 120 may thus represent an initial time point for the measurement of time-of-flight of the transmit signal 122. Time-of-flight measurements may usually be based on light emission and detection, so that the transmit signal 122 may be, in a relevant use case, a light signal. However, time-of-flight measurements may also make use of other signal types, such as sound waves, so that the transmit signal 122 may alternatively be a sound wave, or a different type of signal.

For a direct time-of-flight measurement, the processing circuit 102 may be configured to generate a stop signal 126 representative of an arrival (e.g., of a reception) of the receive signal 108 at the detection device 100, and may be configured to determine (e.g., calculate) the time-of-flight as a time difference between the start signal 120 and the stop signal 126 (illustratively, a time difference between the time points represented by the start signal and stop signal). The stop signal 126 may represent or indicate a time point at which the reflection of the transmit signal 122 is detected at the detection device 100. Illustratively, the stop signal 126 may represent a time of arrival of the signal component of the receive signal 108 at the detection device 100 (e.g., at the detector 118).

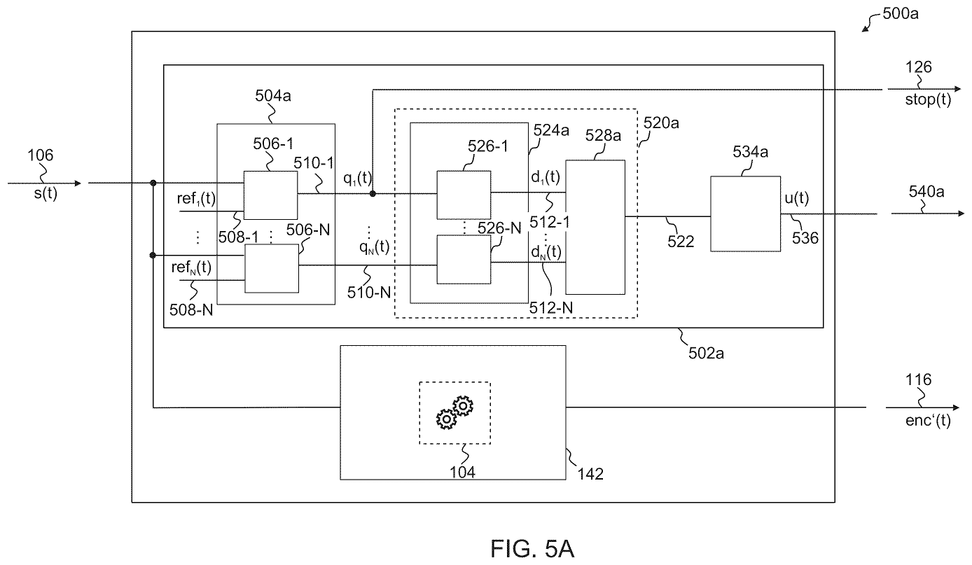

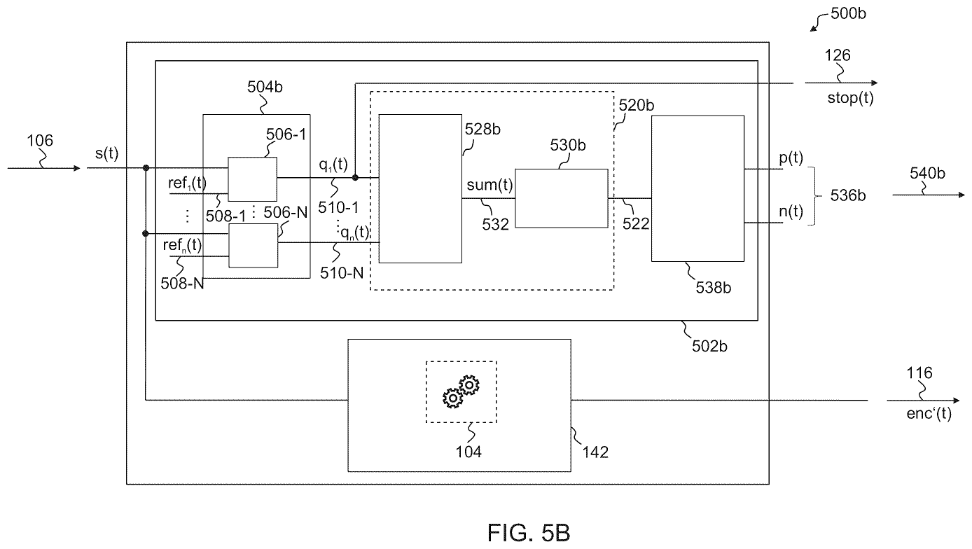

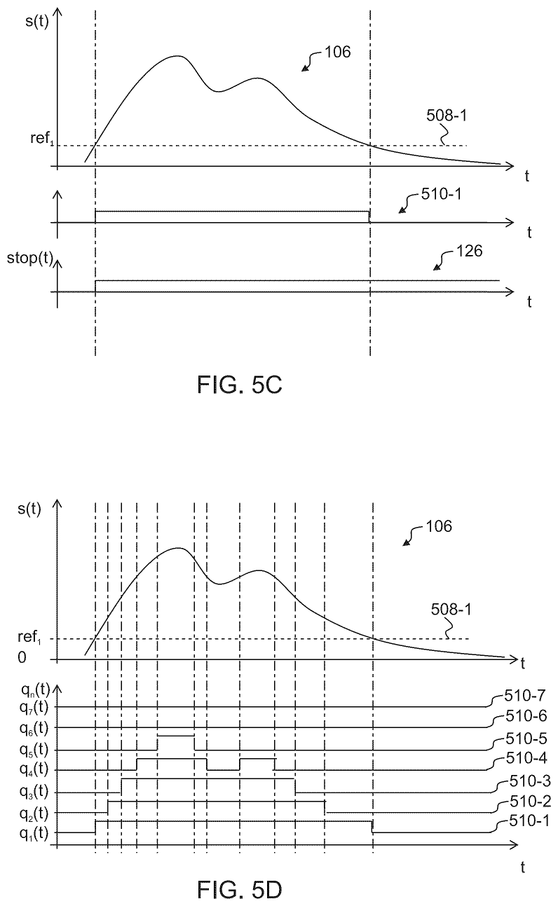

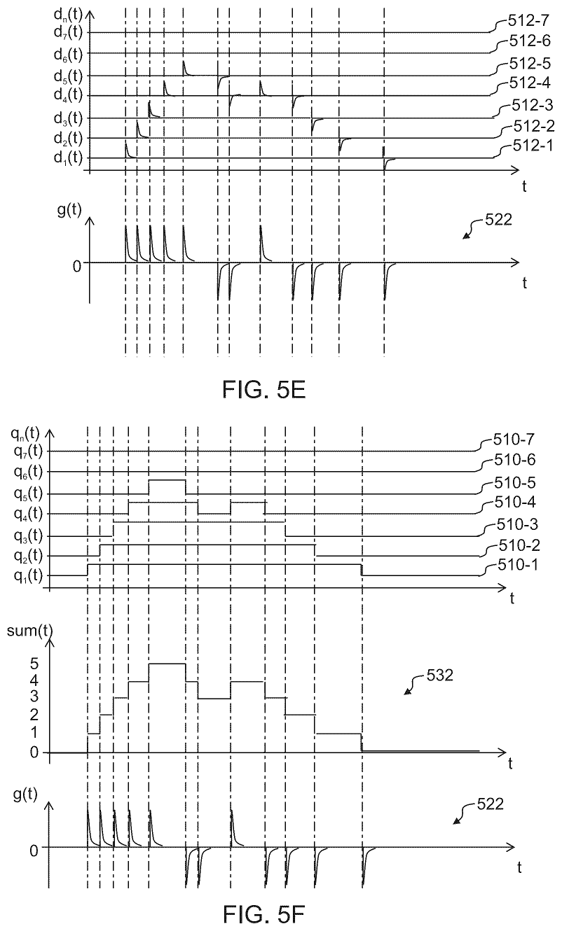

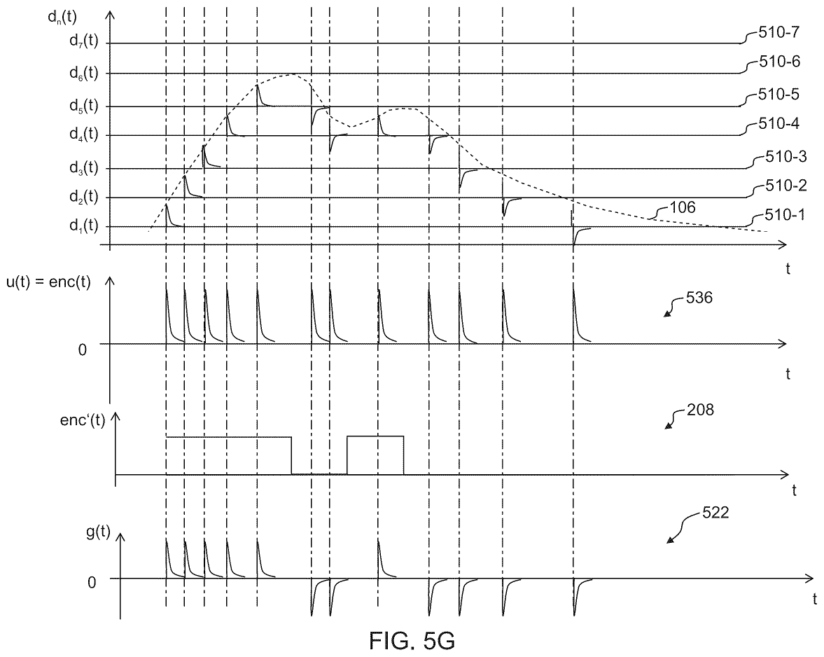

There may be various strategies for generating the stop signal 126 based on the detection signal 106 delivered by the detector 118. Illustratively, there may be various stop signal generation methods 128 that the processing circuit 102 may implement. In a simple implementation the processing circuit 102 may be configured to compare a signal level of the detection signal 106 with a predefined threshold level (e.g., an average noise level), and may be configured to generate the stop signal 126 in the case that the signal level of the detection signal 106 is greater than the predefined threshold level. More in general, the processing circuit 102 may be configured to generate the stop signal 126 in the case that the signal level of the detection signal 106 is in a predefined signal range (illustratively, a range for which it may be assumed that the detection signal 106 corresponds to a reflection of the transmit signal 122 and not to noise from the environment). Thus, considering an analog implementation, the processing circuit 102 may include a comparator configured to compare the detection signal 106 with a reference signal (e.g., a reference voltage) representative of the predefined threshold level, and the stop signal 126 may be the output of the comparator (turning high in case the signal level of the detection signal 106 is greater than the threshold level). Further possible configurations will be described in more detail in relation to FIG. 5A to FIG. 5G.

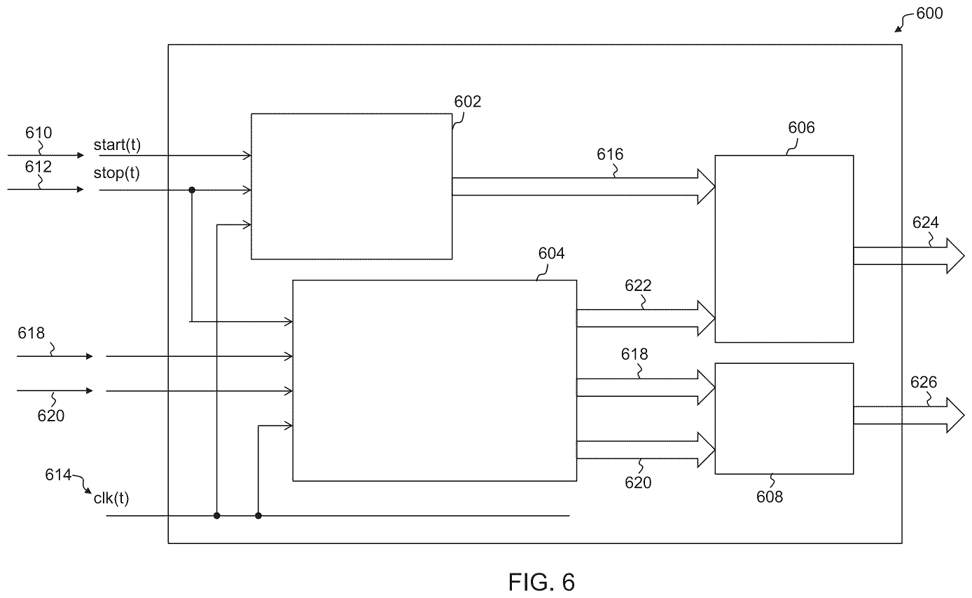

The processing circuit 102 may be configured to determine the time-of-flight associated with the transmit signal 122 based on the start signal 120 and on the stop signal 126. In a preferred configuration, the processing circuit 102 may be configured to carry out a time-to-digital conversion 130 using the start signal 120 and the stop signal 126 to calculate the time-of-flight, e.g. to generate a digital signal 132 representative of the time-of-flight. The time-to-digital conversion 130 may express in a digital manner the time difference between receiving the start signal 120 and generating the stop signal 126. As an exemplary configuration, the processing circuit 102 may be configured to determine the time-of-flight associated with the transmit signal 122 as a number of clock cycles from receiving the start signal 120 to generating the stop signal 126, e.g. a number of clock cycles from a rising edge of the start signal 120 to a rising edge of the stop signal 126. In some embodiments, the processing circuit 102 may include a time-to-digital converter circuit configured to receive the start signal 120 and stop signal 126, and to generate a corresponding digital output signal 132. A more detailed description of a possible configuration of the time-to-digital converter circuit will be provided in relation to FIG. 6.

The processing circuit 102 may be configured to use the analysis of the rate of change of the signal level of the detection signal 106 to refine the time-of-flight measurement. The processing circuit 102 may be configured to generate one or more adjustment values for the time-of-flight based on the output signal 116. The adjustment may be based on the characteristic properties of the receive signal 108 (e.g., shape information) that the output signal 116 encodes, e.g. on the time location of the characteristic portions 114 of the detection signal 106 (and accordingly of the receive signal 108). The processing circuit 102 may thus be configured to modify the value of the time-of-flight based on the determined time points 112, e.g. in accordance with the determined time locations of the one or more characteristic portions 114.

As an example, the processing circuit 102 may be configured to modify the value of the determined time-of-flight based on a time-location of a first peak of the detection signal 106 (and this information may be encoded in the output signal 116, as further discussed in relation to FIG. 2A to FIG. 2F), accordingly a first peak of the receive signal 108. In general, the shape information encoded in the output signal 116 may allow correcting the timing of the generation of the stop signal 126. For example, it may be the case that the signal level of the detection signal 106 is reduced by environmental conditions, e.g. due to reflection from a particularly absorbing surface, due to particular noise conditions, and the like. In this scenario, the stop signal 126 may be generated with a delay with respect to the actual arrival of the reflection of the transmit signal 122 at the detection device 100, since the signal level of the detection signal 106 remains below the noise threshold for longer than usual. The shape information encoded in the output signal 116 may provide correcting such delay, e.g. by estimating when the stop signal 126 should have been generated, thus adjusting the determined time-of-flight. The processing circuit 102 may thus be configured to correct a delay in the generation of the stop signal 126 based on the determined time points 112.

It is understood that the use of the time location of the first peak in the detection signal 106 to adjust the measurement of the time-of-flight is only an example, and other adjustments based on the reconstructed properties of the receive signal 108 may be provided. As another example, the processing circuit 102 may be configured to modify the value of the determined time-of-flight based on a number of peaks in the detection signal 106. Illustratively, in a direct time-of-flight measurement, the transmit signal 122 may include a single light pulse, so that the presence of more than one peak in the receive signal 108 may indicate reflections from multiple objects in the field of view. The number of peaks may represent the number of objects by which the transmit signal 122 was reflected. Accordingly, the processing circuit 102 may be configured to use a time distance between two peaks in the detection signal 106 to determine (e.g., estimate, or calculate) a relative distance between two objects in the field of view, and optionally adapt a determined time-of-flight value based on such relative distance.

By way of illustration, the processing circuit may include a stop signal generation circuit 140, a signal differentiation circuit 142, and a time-of-flight determination circuit 144 configured to carry out the respective operations mentioned above. In an exemplary configuration, the stop signal generation circuit 140 and the signal differentiation circuit 142 may be part of an analog portion 150a of the processing circuit 102, e.g. may include analog components to carry out the respective operation in an analog manner. The time-of-flight determination circuit 144 may be part of a digital portion 150b of the processing circuit 102 and may be configured to carry out the respective operation in a digital manner. The analog portion of the processing circuit 102 may illustratively be an analog signal processing stage, and the digital portion may be a digital signal processing stage.

FIG. 1C shows the detection device 100 further including a signal emission circuit 100a configured to emit the transmit signal 122. In this configuration, the processing circuit 102 may be part of a signal detection circuit 100b of the detection device 100. The transmit signal 122 may also be referred to herein as emit signal. It is however understood that, in general, the transmit signal 122 may be emitted by an entity other than the detection device 100, e.g. by a light emission system external to the detection device 100.

The signal emission circuit 100a may include a signal source 134 configured to emit (in some embodiments, to radiate) the transmit signal 122, and a controller 136 configured to control the signal source 134 to control (e.g., to cause) the emission of the transmit signal 122. In the following, particular reference is made to the emission of a light signal 122, so that the signal source 134 may be a light source. It is however understood that the embodiments described in relation to a light source may apply in a corresponding manner to sources of other types of signal, e.g. a radio transmitter for emitting radio waves, a membrane for radiating sound waves, etc.

In various embodiments, the signal source 134 may be or include a light source configured to emit light. The light source 134 may be configured to emit light having a predefined wavelength, for example in the visible range (e.g., from about 380 nm to about 700 nm), infra-red and/or near infra-red range (e.g., in the range from about 700 nm to about 5000 nm, for example in the range from about 860 nm to about 1600 nm, or for example at 905 nm or 1550 nm), or ultraviolet range (e.g., from about 100 nm to about 400 nm). In some embodiments, the light source 134 may be or may include an optoelectronic light source (e.g., a laser source). As an example, the light source 134 may include one or more light emitting diodes. As another example the light source may include one or more laser diodes, e.g. one or more edge-emitting laser diodes or one or more vertical cavity surface emitting laser diodes. In various embodiments, the light source 134 may include a plurality of emitter pixels, e.g. the light source 134 may include an emitter array having a plurality of emitter pixels. For example, the plurality of emitter pixels may be or may include a plurality of laser diodes.

The controller 136 may be configured to deliver a control signal 138 to the light source 134 to cause the emission of light, e.g. emission of the transmit signal 122. In various embodiments, the controller 136 may be configured to encode the control signal 138 to cause emission of a modulated transmit signal. Illustratively, in a simple configuration, e.g. for a time-of-flight measurement, the transmit signal 122 may include a light pulse, whose echo is received as receive signal 108. In a more advanced configuration, the transmit signal 122 may include a plurality of light pulses, and the properties of the light pulses (e.g., a number, a distance between pulses, etc.) may be selected according to a predefined modulation scheme (e.g., to encode data in the emitted light signal 122, to characterize the light signal in a unique manner, and the like). Illustratively, in some embodiments, the transmit signal 122 may be a light signal modulated to include one or more characteristic portions according to a predefined modulation scheme. In an exemplary configuration, the light source 134 may include a driving circuit configured to drive the light emission, and the controller 136 may be configured to deliver the control signal 138 to the driving circuit.

The control signal 138 may include the start signal 120 delivered to the processing circuit 102. Illustratively, the controller 134 may be configured to send the control signal 138 to the light source 132, and to indicate the start of the light emission to the processing circuit 102 via the start signal 120.

In an exemplary configuration, the controller 136 may be external to the signal emission circuit 100a and/or external to the detection device 100. In this scenario, the detection device 100 may be communicatively coupled to the external controller 136. For example, the controller 136 may be a measurement control circuit of a LIDAR system. As another example, the controller 136 may be a central processing circuit of a vehicle.

In the context of light detection, the detector 118 may include one or more photo diodes, for example a one-dimensional array of photo diodes or a two-dimensional array of photo diodes. As examples, the detector 118 may include at least one of a PIN photo diode, an avalanche photo diode (APD), a single-photon avalanche photo diode (SPAD), or a silicon photomultiplier (SiPM). A photo diode may generate a corresponding current upon light impinging onto the photo diode, and the current(s) generated by the one or more photo diodes may be delivered as detection signal 106 to the processing circuit 102 (or as voltage upon conversion via a transimpedance amplifier).

In an exemplary configuration, which may provide a targeted illumination of the field of view and accordingly an increased signal-to-noise ratio for areas of interest, the detector 118 may include a two-dimensional array of (detector) pixels, and the light detection may be carried out by activating only some of the pixels during a detection interval. In this scenario, the detector 118 may include a processor configured to control the detector 118 to sequentially activate pixels of the pixel array, so that during a detection interval one or more pixels are active (illustratively, sensitive for the incoming light), and one or more other of the pixels are inactive (insensitive for the incoming light). Activating a pixel may include, for example, supplying a bias voltage to the pixel. The processor may be configured to activate the pixels of the pixel array pixel by pixel, row by row, or column by column, as examples, to sequentially detect light from different regions of the field of view of the detection device 100. In this configuration, the detection signal 106 may include a plurality of partial detection signals, e.g. each corresponding to the active pixels during a respective detection interval.

The sequential pixel activation may be coordinated with a sequential illumination of the field of view. In this configuration, the light source 134 may include an array of emitter pixels, e.g. an array of light emitting diodes or laser diodes. The array of emitter pixels may be one-dimensional, or two-dimensional. For example, a two-dimensional emitter array may allow providing 2D-Flood, 1D-Row, 1D-Column, or Pixel-wise illumination. The controller 136 may be configured to control the emitter pixels in such a way that during an emission interval (e.g., corresponding in duration with a detection interval) one or more of the emitter pixels are active and emit light, and one or more other of the emitter pixels are inactive and do not emit light. In an exemplary configuration, the controller 136 may be configured to send a synchronization signal to the light source 134, and the synchronization signal may be representative of the emitter pixels to activate during a respective emission interval. The synchronization signal may illustratively indicate the time sequence for the activation of the emitter pixels, e.g. in a pixel by pixel, row by row, or column by column fashion. The controller 136 may be configured to send the synchronization signal also to the detector 118 to synchronize the activation of the detector pixels with the activation of the emitter pixels (and thus reduce an overall noise of the measurement). The synchronization signal may thus further be representative of the detector pixels to activate during a respective detection interval, e.g. in a pixel by pixel, row by row, or column by column fashion.

In this scenario, the processing circuit 102 may be configured to generate a plurality of partial differentiation signals (and corresponding output signals) and, in some embodiments, a plurality of partial stop signals, e.g. one partial detection/stop signal for each partial detection signal.

In general, the reconstruction of the receive signal 108 may be used for other purposes in addition to time-of-flight measurements, which provides a relevant use case. As other examples, the reconstruction of the receive signal 108 may allow estimating properties of the environment in which the transmit signal 122 propagates, or may allow decoding information that was encoded in the transmit signal.

Various embodiments of the operation of the processing circuit 102 will be described in relation to FIG. 2A to FIG. 2F. In general, the components described in relation to FIG. 2A to FIG. 2F may be part of the signal differentiation circuit 142 of the processing circuit 102.

As shown in FIG. 2A, the processing circuit 102 may include a differentiation circuit 202 configured to receive, as input, the detection signal 106 (or its filtered version in case the processing circuit 102 includes, optionally, a filtering circuit 204, configured as discussed in relation to FIG. 1) and generate, as output, the differentiation signal 110. The differentiation circuit 202 may be in general part of a differentiation stage, optionally including filtering to perform signal conditioning prior to and/or during the differentiation process. In an exemplary configuration, the filtering circuit 204 may include aggressive low-pass filters to reduce the noise power and provide a “clean” signal as input to the differentiation stage 202. Additionally or alternatively the differentiation circuit 202 may itself be designed to perform filtering as part of the differentiation process, e.g. for operational amplifier-based implementations the roll of components may be chosen to avoid some instabilities, which also affects the bandwidth of the differentiation stage 202.

As discussed in relation to FIG. 1A, in general the various operations of the processing circuit 102 may be carried out in the digital domain or in the analog domain. For example, for a digital implementation, the processing circuit 102 may include an analog-to-digital converter (ADC) to convert the analog detection signal 106 from the detector 118 into a digital signal prior to being further processed. However, for example for ToF measurements, an ADC capable of sampling the detected signal may require high speed, and thus may be a complex and expensive component. Therefore, in a preferred configuration, the differentiation circuit 202 may be or include an analog differentiation circuit (illustratively, an analog differentiator). As shown in the inset 210 in FIG. 2A, which shows an exemplary realization, the analog differentiation circuit may include an operational amplifier 212 configured to receive, at one input, the detection signal 106, carry out an analog differentiation of the detection signal and provide, at the output, the differentiation signal 110.

In a preferred configuration, the processing circuit 102 may be configured to generate the differentiation signal 110 by determining (e.g., calculating, or generating) a first-order derivative of the detection signal 106. In the analog configuration, this function may be implemented by the analog differentiator, configured to carry out an analog differentiation of the detection signal 106 and deliver, as output, the differentiation signal 110 representative of the first-order derivative. It is however understood that, in general, also other (e.g., more complex) approaches may exist to evaluate the rate of change over time of the detection signal 106, for example in the digital domain based on an image analysis of a graphical representation of the detection signal 106.

The time points 112 corresponding to the change of the sign of the differentiation signal 106 may be representative of local minima and/or local maxima in the detection signal 106. Illustratively, the sign change in the rate of change over time of the detection signal 106 may indicate that the signal level of the detection signal 106 stops increasing and starts decreasing (local maximum), or vice versa (local minimum). The time points 112 at which the rate of change is zero (illustratively, the time points 112 at which the signal level of the differentiation signal 110 is zero) may correspond to the time points at which a local maximum or local minimum is located in the detection signal 106.

According to various embodiments, the processing circuit 102 may be configured to determine the time points 112 by determining one or more zero-crossings of the differentiation signal 110. Illustratively, the portions of the detection signal 110 at which the signal level is zero and then becomes positive may correspond to a local minimum (e.g., a valley in the detection signal 106), whereas the portions of the detection signal 110 at which the signal level is zero and then becomes negative may correspond to a local maximum (e.g., a peak in the detection signal 106). A zero-crossing may correspond to an intercept of the time axis in a graph representing the differentiation signal 110.

To implement the zero-crossing detection, the processing circuit 102 may include a zero-crossing detector 206 configured to receive, as input signal, the differentiation signal 110 and provide (e.g., generate, or deliver), as output signal, a zero-crossing signal 208 ZC_s′(t) representative of the zero-crossings of the differentiation signal 110 (and accordingly of the time points 112). The zero-crossing detector 206 may be configured to compare the signal level of the detection signal 110 with a predefined threshold value (e.g., zero, for example expressed in Volts, considering an analog implementation), and may be configured to output the zero-crossing signal 208 at a first signal level (e.g., a high level) in case the signal level of the differentiation signal 110 is equal to or above the predefined threshold value, and may be configured to output the zero-crossing signal 208 at a second signal level (e.g., a low level, less than the first level, e.g. zero) in case the signal level of the differentiation signal 110 is less than the predefined threshold value. As shown in FIG. 2A, the zero-crossing signal 208 may have a square-like waveform, switching from high to low, or vice versa, in correspondence of the time points 112. This type of representation of the zero-crossing provides an approach that may be conveniently implemented, but it is understood that other types of representation (e.g., other types of encoding) may be provided. The zero-crossing signal 208 may also be referred to herein as zero-crossing output signal 208.

Considering an analog implementation, the zero-crossing detector 206 may be or include an analog comparator, as shown in the inset 220, e.g. including a differential amplifier 222 configured to compare the differentiation signal 110 with a reference signal 224 and generate a corresponding output zero-crossing signal 208. For example, the differential amplifier 222 may be configured to compare a voltage corresponding to the differentiation signal 110 with a reference voltage (e.g., 0 Volts).

The zero-crossing signal 208 may encode the information representing the time points 112, and may thus encode in a direct and simply obtainable manner the time locations of the characteristic portions 114 of the detection signal 106. The processing circuit 102 may be configured to determine the time points 112 corresponding to a change of a sign of the differentiation signal 110 based on the time points corresponding to the output of the zero-crossing detector 206 switching from the first signal level to the second signal level, or vice versa. Illustratively, considering the exemplary scenario in FIG. 2A, a falling edge of the zero-crossing signal 208 may correspond to a peak in the detection signal 106, and a rising edge of the zero-crossing signal 208 may correspond to a valley in the detection signal 106. The so-generated zero-crossing signal 208 may thus offer a compact and convenient representation of relevant shape-characteristics of the detection signal 106 (and accordingly of the receive signal 108), to enable a further, more advanced processing (e.g., at the digital signal processing stage).

Stated in a different fashion, the zero-crossing of the first derivative s′(t) may allow finding a peak or a valley (a local maximum or minimum). The output of the zero-crossing detector 206 ZC_s′(t) may switch between a “high” and “low” state as the input signal s′(t) changes from positive to negative. This behavior may for example be realized with a comparator having a reference level of zero (or near zero). The change from “high” to “low” or from “low” to “high” provides information whether the derivative signal s′(t) had a negative or positive slope during zero crossing. As an example, in the case of s′(t) it provides information whether there was a local minimum or maximum.

In a simple configuration, the zero-crossing signal 208 may thus be provided as output signal 116 for further processing. In other embodiments, however, the processing circuit 102 may be configured to further process the information (e.g., to further process the zero-crossing signal 208) to facilitate subsequent decoding by a digital circuit. Illustratively, in some embodiments, the processing circuit 102 may include an encoding circuit configured to encode the information representing the time points 112 in a format that may be more easily decoded in the digital domain. This optional signal encoding stage allows to represent the zero-crossing signals of the first derivative in a way that simplifies subsequent signal processing steps (e.g., to create a more sparse signal that may be compressed more easily).

As shown in FIG. 2B and FIG. 2C, the processing circuit 102 may be further configured to generate an encoded sparse signal 216 representative of the time points 112 corresponding to the change of the sign of the differentiation signal 110. The signal 216 may be a sparse signal, including signal components only in correspondence of the time points 112 (and may be zero elsewhere). Illustratively, the encoded sparse signal 216 may be at a first signal level (e.g., a signal level different from zero, e.g. a signal level greater than zero) in correspondence of the time points 112 and may be at a second signal level (e.g., a signal level of substantially zero) in the remaining portions of the encoded sparse signal 216 (e.g., in correspondence of other portions of the detection signal 106). Illustratively, the encoded sparse signal 216 may include one or more spikes, or pulses, in correspondence of the time points 112. The encoded sparse signal 216 may thus be provided as output signal 116 for further processing (in alternative or in addition to the zero-crossing signal 208), providing a more compact representation of the relevant information of the detection signal 106. Illustratively, the processing circuit 102 may be configured to generate the output signal 116 by encoding the determined time points 112 via the encoded sparse signal 216.

The processing circuit 102 may be configured, in some embodiments, to carry out the reconstruction of the receive signal 108 (and/or a refinement of the time-of-flight, as discussed below) using the encoded sparse signal 216. In general, the processing circuit 102 may include an encoder circuit 214 configured to generate the encoded sparse signal 216.

There may be various options to generate a sparse signal 216. Two exemplary configurations providing respective encoded sparse signals 216a, 216b are shown in FIG. 2B and FIG. 2C. Such exemplary configurations provide a simple integration of this functionality in the processing circuit 102, but it is understood that also other solutions may be provided.

As an exemplary configuration, as shown in FIG. 2B, the encoder circuit 214 may be configured to detect the edges of the zero-crossing signal 208 to generate the encoded sparse signal 216a u′(t) (an example of encoded sparse signal 216). The encoder circuit 214 may thus be configured as an edge-detection circuit configured to receive the output 208 of the zero-crossing detector 206 and generate an encoded zero crossing signal 216a. The encoded sparse signal 216a may illustratively include signal pulses in correspondence of the rising/falling edges of the zero-crossing signal 208. As shown in FIG. 2B, the encoder circuit 214 may be configured to generate the encoded sparse signal 216a as a unipolar signal, u′(t), or as a pair of signals including a first encoded signal p_s′(t) representative of the rising edges of the zero-crossing signal 208, and a second encoded signal n_s′(t) representative of the falling edges of the zero-crossing signal 208.

Considering an analog implementation, as shown in the inset 240, the encoder circuit 214 may include an analog edge detector, e.g. including a flip-flop 242 configured to receive the zero-crossing signal 208 at a first input (d) and a clock signal 244 at a second input (clk), and including a XOR logic gate 246 configured to receive, as inputs, the zero-crossing signal 208 and the output (q) of the flip-flop 242. The encoded signal 216a may correspond to the output of the XOR logic gate 246. The configuration in the inset 240 may provide detecting both rising and falling edges of the zero-crossing signal 208. The configuration may be correspondingly adapted to detect only the rising edges (e.g., to provide the first encoded signal p_s′(t)) and/or only the falling edges (e.g., to provide the second encoded signal n_s′(t)).

As another exemplary configuration, as shown in FIG. 2C, the encoder circuit 214 may be configured to differentiate the zero-crossing signal 208 to generate the encoded sparse signal 216b diff_s′(t) (an example of encoded sparse signal 216). The encoder circuit 214 may thus be configured a differentiation circuit (e.g., including an analog differentiator, for example configured as the differentiator in the inset 210), configured to receive the output 208 of the zero-crossing detector 206 and generate a differentiated zero crossing signal 216b. In view of the square-like waveform of the zero-crossing signal 208, its derivative may be (substantially) zero except in correspondence of the rising or falling edges, thus providing a sparse encoding of the relevant portions of the zero-crossing signal 208. As shown in FIG. 2C, the encoder circuit 214 may be configured to generate the encoded sparse signal 216b as an individual signal, diff_s′(t), or as a pair of signals including a first encoded signal p_s′(t) representative of the rising edges of the zero-crossing signal 208, and a second encoded signal n_s′(t) representative of the falling edges of the zero-crossing signal 208. For example, the encoder circuit 214 may include a rectifier configured to rectify the output of the differentiator to provide the first and second encoded signals

Depending on the architecture of the detection device 100 (e.g., of the time-to-digital converter), the pulse-like (or “event-like”) representation of the zero-crossing information provided by the encoded sparse signal 216a, 216 may be more suitable for processing. Also in this example, it is possible to encode the direction of the zero-crossing (from positive to negative or vice versa) in the polarity of the encoded pulse-like signal.

According to various embodiments, as shown in FIG. 2D to FIG. 2F, the processing circuit 102 may be further configured to determine a rate of change of the differentiation signal 110, to obtain additional information for the signal reconstruction (and/or time-of-flight refinement).

The processing circuit 102 may be configured to generate a further (e.g., second) differentiation signal 252 s″(t) representative of a rate of change of a signal level of the differentiation signal 110 over time. The second differentiation signal 252 may thus vary over time according to the variation of the signal level of the differentiation signal 110. In a preferred configuration, the processing circuit 102 may be configured to generate the second differentiation signal 252 by determining (e.g., calculating, or generating) a second-order derivative of the detection signal 106 (or a first-order derivative of the differentiation signal 110).

The processing circuit 102 may be further configured to determine (e.g., identify) further (e.g., second) time points 254 corresponding to a change of a sign of the second differentiation signal 252, e.g. from positive to negative or from negative to positive. The processing circuit 102 may be configured to encode the determined second time points 254 to generate a second output signal representative of one or more second characteristic properties of the receive signal detected at the detection device. The second output signal may be a separate signal, or may be part of the (first) output signal 116. According to various embodiments, the processing circuit 102 may be configured to store the second output signal, e.g. in a memory of the processing circuit 102 (e.g., a buffer) and retrieve the stored second output signal during a subsequent processing.

The second time points 254 may correspond to local minima or local maxima in the (first) differentiation signal 110, and may correspond to inflection points in the detection signal 106. Illustratively, the second time points 254 may be in correspondence of portions of the detection signal 106 in which the concavity of the detection signal 106 (illustratively, of its representation in a graph) changes.

The characterization of the second differentiation signal 252 may thus provide additional information about the waveform of the detection signal 106 (and accordingly of the receive signal 108). The processing circuit 102 may be further configured to carry out the reconstruction of the receive signal 108 based (additionally or alternatively) on the determined second time points 254. In some embodiments, the reconstruction may be further be based on predefined second time points of the predefined receive signals (e.g., based on a knowledge of expected time locations of inflection points within predefined receive signals). In some embodiments, the processing circuit 102 may be further configured to use the determined second time points 254 for modifying the value of the determined time-of-flight associated with the transmit signal 122, as discussed in relation to FIG. 1B and FIG. 1C.

As shown in FIG. 2D, the processing circuit 102 may include a further (second) differentiation circuit 202b configured to receive, as input, the differentiation signal 110 and generate, as output, the second differentiation signal 252. In some embodiments, the differentiation circuit 202 and the second differentiation circuit 202b may be understood, together, as a differentiation stage. As discussed for the differentiation circuit 202, the second differentiation circuit 202b may in general carry out its operation in the digital domain or in the analog domain. In a preferred configuration, the second differentiation circuit 202b may be an analog circuit, e.g. an analog differentiation (for example configured as shown in the inset 210 in FIG. 2A for the first differentiation circuit 202). The second analog differentiation circuit 202b may illustratively be configured to carry out an analog differentiation of the differentiation signal 110 to determine the second-order derivative of the detection signal 106, and deliver, as output, the second differentiation signal 252 representative of the second-order derivative.

As described in relation to the (first) differentiation signal 110, the processing circuit 102 may be configured to determine the time points 254 corresponding to a change of a sign of the second differentiation signal 252 by determining one or more zero-crossings of the second differentiation signal 252. The time points 254 (and in a corresponding manner the time points 112) may thus correspond to points on the time axis at which a function representing the second differentiation signal 252 crosses the time axis.

As shown in FIG. 2D, the processing circuit 102 may include a second zero-crossing detector 206b, which may be configured in a same or similar manner as the (first) zero-crossing detector 206. In brief, the second zero-crossing detector 206b may be configured to receive the second differentiation signal and provide (e.g., generate, or deliver), as output, a zero-crossing signal 256 ZC_s″(t) at a first signal level in case the signal level of the second differentiation signal 252 is equal to or greater than a predefined threshold value (e.g., a threshold value of zero), and at a second signal level (less than the first signal level, e.g. zero) in case the signal level of the second differentiation signal 252 is less than the predefined threshold value. The zero-crossing signal 256 may also be referred to as zero-crossing output signal 256.

The processing circuit 102 may be configured to determine the time points 254 based on the time points corresponding to the output of the second zero-crossing detector 206b switching from the first signal level to the second signal level, or vice versa. Illustratively, considering the exemplary scenario in FIG. 2D, a rising edge of the second zero-crossing signal 256 may correspond to an inflection point in the detection signal 106 in which the concavity changes from upward to downward, and a falling edge of the second zero-crossing signal 256 may correspond to an inflection point in the detection signal 106 in which the concavity changes from downward to upward. The second zero-crossing signal 256 may thus offer a compact and convenient representation of relevant shape-characteristics of the detection signal 106 (and accordingly of the receive signal 108), to enable the further processing.

In a simple configuration, the second zero-crossing signal 256 may thus be provided as part of the second output signal (or as part of the output signal 116) for further processing, e.g. alone or together with the zero-crossing signal 208. In other embodiments, in a similar manner as discussed in relation to FIG. 2B and FIG. 2C, the processing circuit 102 may be configured to further encode the second zero-crossing signal 256 to facilitate the subsequent (digital) processing.

As shown in FIG. 2E and FIG. 2F, the processing circuit 102 may be further configured to generate a further (second) encoded sparse signal 258 representative of the time points 254 corresponding to the change of the sign of the second differentiation signal 252. The signal 258 may be a sparse signal, e.g. the second encoded sparse signal 258 may be at a first signal level (e.g., a high level, different from zero, e.g. greater than zero) in correspondence of the time points 254 and may be at a second signal level (e.g., a low level, such as substantially zero) in the remaining portions of the second encoded sparse signal 258 (e.g., in correspondence of other portions of the differentiation signal 110). The processing circuit 102 may thus be configured to generate the second output signal by encoding the determined time points 252 via the second encoded sparse signal 258. The second encoded sparse signal 258 may thus be provided for further processing (in alternative or in addition to the zero-crossing signal 256). The processing circuit 102 may thus be configured, in some embodiments, to carry out the reconstruction of the receive signal 108 (and/or a refinement of the time-of-flight) using the second encoded signal 258. In general, the processing circuit 102 may include a second encoder circuit 214b configured to receive the output of the second zero-crossing detector 206b and generate the second encoded sparse signal 258.

As discussed in relation to FIG. 2B and FIG. 2C, there may be various options to generate a sparse encoded signal 258. As an exemplary configuration, as shown in FIG. 2E, the second encoder circuit 214b may be configured to detect the edges of the second zero-crossing signal 256 to generate the encoded sparse signal 258a. The encoder circuit 214 may thus be configured as an edge-detection circuit. As shown in FIG. 2E, the second encoder circuit 214b may be configured to generate the encoded sparse signal 258a as a unipolar signal, u″(t), or as a pair of signals including a first encoded signal p_s″(t) representative of the rising edges of the second zero-crossing signal 256, and a second encoded signal n_s″(t) representative of the falling edges of the second zero-crossing signal 256.

As another exemplary configuration, as shown in FIG. 2F, the second encoder circuit 214b may be configured to differentiate the second zero-crossing signal 256 to generate the second encoded sparse signal 258b diff_s′(t). As shown in FIG. 2F, the second encoder circuit 214b may be configured to generate the second encoded sparse signal 258b as an individual signal, diff_s′(t), or as a pair of signals including a first encoded signal p_s′(t) and a second encoded signal n_s′(t).

The processing circuit 102 (e.g., its digital portion) may be configured to carry out subsequent data processing to derive the measures of interest, such as: determine the number and the (temporal) position of the peak(s) in the echo using the encoded zero-crossing signal of the second derivative; use the position of the main peak to refine the time-of-flight measurement in order to reduce the walk error; determine the number of detected objects in the field of view; and the like.

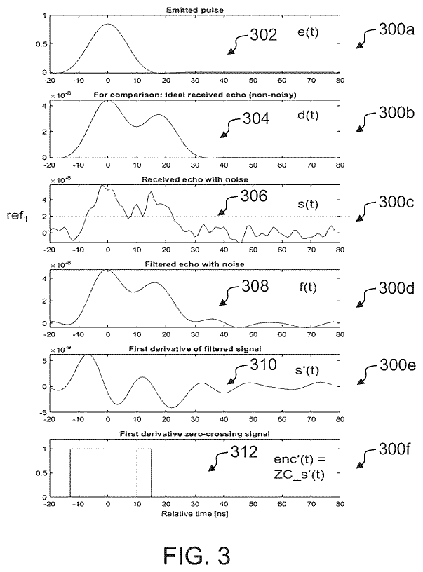

FIG. 3 shows a series of graphs 300a-300f illustrating an operation of the detection device 100. The graphs 300a-300f may describe the various processing steps in an exemplary scenario, to illustrate the various functionalities discussed in relation to FIG. 1A to FIG. 2F. The graphs may represent a signal level of the various signals (in arbitrary units) over time.

The graph 300a shows an emitted light pulse 302 (an example of transmit signal 122), corresponding to the signal e(t). As an example, the emitted light pulse 302 may be a Gauss pulse with a pulse duration of approximately 15 ns (FWHM).

The graph 300b shows an exemplary receive signal 304, d(t) (an example of receive signal 108). The signal d(t) may correspond to the received light signal, including the attenuated echo(s) of the emitted pulse 302, after hitting an object. In the exemplary scenario in FIG. 3, the receive signal 304 may include two overlapping echos showing as two peaks in the received light signal d(t), e.g. indicating reflection from two objects in the field of view.

As shown in the graph 300c, the received light signal d(t) is converted into an electrical signal 306 by the detector (the signal 306 may be an example for the detection signal 106). Upon detection, the noisy detected signal s(t) is obtained. In the exemplary scenario in FIG. 3, the noise may have a signal-to-noise ratio of 6 dB, filtered by a lower-order low-pass filter modelling the typical bandwidth of the input transimpedance amplifier. In this example the detected signal s(t) may also be used to create the stop signal for time-of-flight measurement, stop(t), using a threshold level ref₁.

As the received signal is very noisy, strong low-pass filtering may be applied to create a “smooth” filtered signal 308 f(t), shown in graph 300d, that is suitable for differentiation. In order to precondition the signal for differentiation, a filter may be applied prior to the differentiation stage, e.g. a low-pass filter may be applied to reduce the impact of noise in the derivative signal.

The filtered signal then undergoes a differentiation to obtain the differentiated signal 310 s′(t), shown in graph 300e. The signal 310 s′(t) may be an example of differentiation signal 110. The input signal s(t) or f(t) may be differentiated, e.g. as a first-and/or second-order derivative. In analog electronics, an operating amplifier-based circuit may be used. The outputs of the differentiation stage(s) may be the first derivative of the signal, s′(t), and/or the second derivative of the signal, s″(t).

After zero-crossing detection the zero-crossing signal 312 enc′(t), shown in graph 300f, may be obtained. The zero-crossing signal 312 may be an example of output signal 116. In this example no further encoding of the zero-crossing signal is performed. In this case the output signals enc′(t) may correspond to zero-crossing signal ZC_s′(t). To determine an inflection point, similarly a zero crossing of the second derivative s″(t) may be determined (and optionally encoded).

Despite its simplicity, the proposed setup allows to accurately detect the peaks in the received signal which e.g. allows to correct the ToF measurement, e.g. to correct for the walk error.

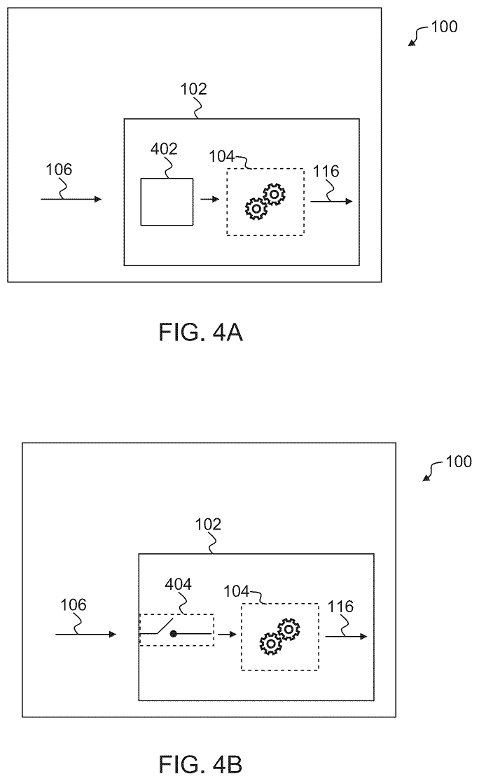

FIG. 4A and FIG. 4B show further embodiments of the detection device 100, which may be combined with the configuration described in relation to FIG. 1A to FIG. 2F.

According to various embodiments, the processing circuit 102 may be configured to delay the generation of the differentiation signal 110 by a predefined time delay from the detection of the receive signal 108 at the detection device 100. Illustratively, the processing circuit 102 may be configured to delay carrying out the generation of the differentiation signal 110 with respect to the time point at which the processing circuit 102 receives the detection signal 106. The predefined time delay may be selected based on an expected duration of the receive signal 108, e.g. an expected duration of a signal component of the receive signal 108. In some embodiments, the predefined time delay may be selected based on a predefined (e.g., known) duration of the transmit signal 122 corresponding to the receive signal 108. The delaying may ensure that the signal component of the receive signal 108 is fully detected at the detection device 100 before the further processing (differentiation, zero-crossing detection, etc.) is carried out. The processing circuit 102 may be configured to adjust the value of the time-of-flight based on the predefined time delay (if implemented), e.g. may be configured to subtract the predefined time delay from the measured time-of-flight.

As an exemplary implementation, the processing circuit 102 may include an analog delay circuit 402 configured to impose the predefined time delay onto the detection signal 106. The analog delay circuit 402 may be disposed upstream of the other components of the processing circuit 102 with respect to the propagation of the detection signal 106 within the processing circuit 102. Illustratively, the analog delay circuit 402 may be configured to receive the detection signal 106 and provide (e.g., deliver) the detection signal 106 to the differentiation circuit(s) of the processing circuit 102 after the predefined time delay. As exemplary components, the analog delay circuit 402 may include an analog delay line, or a printed circuit board (PCB) design.

Depending on the application, it may be desirable to capture a received pulse in its entirety, e.g. including the portion of the signal before s(t) reaches the trigger threshold for generating the stop signal 126. In order to achieve this, while keeping the implementation complexity of the TDC circuit as low as possible, an analog delay may be inserted into the signal path of the derivative signal to be captured. Adding an analog delay may be used to trade off the analog delay implementation complexity with the fine TDC implementation complexity.

According to various embodiments, the processing circuit 102 may be configured to generate the differentiation signal 110 only for the portions of the detection signal 106 having a signal level greater than a predefined threshold level. This configuration may provide carrying out the signal processing without wasting resources for non-relevant parts of the signal, e.g. parts with only noise or excessive noise. In this configuration, the processing circuit 102 may be configured to determine (e.g., measure, or evaluate) a signal level of the detection signal 106 and determine an initial time point for generating the differentiation signal 110 based on the time point at which the signal level of the detection signal becomes greater than a predefined threshold level. The processing circuit 102 may then carry out the generation of the differentiation signal from the initial time point. The predefined threshold level may include, for example, an average noise level.

As an exemplary implementation, as shown in FIG. 4B, the processing circuit 102 may include a switching element 404 (illustratively, an activation switch) operable to connect or disconnect a signal path to the differentiation circuit(s) of the processing circuit 102. The switching element 404 may thus be operable to connect the signal path to enable delivering the detection signal 106 to the differentiation circuit(s), and to disconnect the signal path to prevent delivering the detection signal 106 to the differentiation circuit(s). The processing circuit 102 may be configured to deliver a control signal to activate the switching element 404 in the case that the signal level of the detection signal 106 is or becomes greater than the predefined threshold level.

As an example, the control signal to activate the switching element 404 may be the output signal of a comparator of the stop signal generation circuit 140. In an exemplary configuration, the stop signal 126 may be delivered to the switching element 404 as control signal for activating the switching element 404 (and connecting the signal path) upon the signal level of the detection signal 106 becoming greater than the predefined threshold level. Illustratively, the stop signal 126 may turn high for the signal level of the detection signal 106 becoming greater than the threshold, and such turning high of the stop signal 126 may be a control signal for activating the switching element 404.

The activation switch 404 may be added to the system 100 in order to only perform signal encoding for portions of the received signal where the received signal is above a certain threshold, as random noise will exhibit noise-like zero-crossings of first and second derivatives. In the exemplary configuration mentioned above, only once the comparator is activated, the differentiation stages become active via the activation switch 404, as there is a sufficient probability of receiving an actual signal.

In the following, various embodiments of the generation of the stop signal 126, as well as further options for encoding and reconstructing the receive signal 108 will be described in relation to FIG. 5A to FIG. 5G.

FIG. 5A and FIG. 5B each shows a respective exemplary configuration of an analog portion 500a, 500b of the processing circuit 102 (e.g., an exemplary configuration of the analog portion 150a). Illustratively, FIG. 5A and FIG. 5B illustrate possible configurations for the stop signal generation circuit 502a, 502b of the processing circuit 102 (illustratively, exemplary configurations of the stop signal generation circuit 140). The operation of the stop signal generation circuit 502a, 502b will be described with reference to the exemplary signals shown in FIG. 5C to FIG. 5G. As shown, the stop signal generation circuit 502a, 502b may be part of the analog portion 500a, 500b of the processing circuit 102 together with the signal differentiation circuit 142, which may be configured according to any of the embodiments described in relation to FIG. 1A to FIG. 4B.

According to various embodiments, the processing circuit 102 (e.g., the stop signal generation circuit 502a, 502b) may be configured to generate a plurality of quantization signals 510-1 . . . 510-N (q₁(t)-q_{N}(t)), as shown in FIG. 5C and FIG. 5D. Each quantization signal 510-1 . . . 510-N may be associated with a respective threshold level 508-1 . . . 508-N (ref₁-ref_{N}), and may be representative of the portions of the detection signal 106 having a signal level within a corresponding range defined by the respective threshold level 508-1 . . . 508-N. Illustratively, each quantization signal 510-1 . . . 51-N may be representative of the portions of the detection signal 106 having a signal level greater than the corresponding threshold level 508-1 . . . 508-N.

As shown in FIG. 5A and FIG. 5B, the processing circuit 102 (e.g., as part of the stop signal generation circuit 502a, 502 b) may include a plurality of comparators 506-1 . . . 506-N, each configured to compare the detection signal 106 with one of the threshold levels 508-1 . . . 508-N ref₁-ref_{N}. Illustratively, the plurality of quantization signals 510-1 . . . 510-N may correspond to the output signals of the plurality of comparators 506-1 . . . 506-N. Each comparator 506-1 . . . 506-N may be configured to generate the respective output signal at a first (e.g., high) level in case the signal level of the detection signal is equal to or greater than the respective threshold level, or at a second (e.g., low) level in case the signal level of the detection signal is equal to or greater than the respective threshold level.

Each comparator 506-1 . . . 506-N may be configured to receive the detection signal 106 and a reference signal defining the respective threshold level 508-1 . . . 508-N. The plurality of comparators 506-1 . . . 506-N may form, in an exemplary configuration, a comparator array. By way of illustration, the plurality of comparators 506-1 . . . 506-N may be part of a quantization stage 504a, 504b of the stop signal generation circuit 502a, 502b.

The plurality of threshold levels 508-1 . . . 508-N may have different values to allow capturing in a quantized fashion the detection signal 106 (and accordingly the receive signal 108). For example, the plurality of threshold levels 508-1 . . . 508-N may be spaced from one another at regular intervals. The number of threshold levels 508-1 . . . 508-N (and the corresponding number of comparators 506-1 . . . 506-N) may be adapted depending on a desired granularity for the quantization. The comparator array with N comparators and adequately chosen reference levels may thus be used to represent the signal 106 s(t) in a quantized fashion using the comparator output signals 510-1 . . . 510-N q₁(t), q₂(t), . . . , q_{N} (t) as illustrated in FIG. 5D.

The plurality of quantization signals 510-1 . . . 510-N may thus provide a quantized representation of the detection signal 106.

In an exemplary configuration, the processing circuit may be configured to encode the quantization signals to 510-1 . . . 510-N generate a third output signal representative of one or more third characteristic properties of the receive signal detected at the detection device. The third output signal may be an individual signal, or may be provided as part of the first or second output signals. According to various embodiments, the processing circuit 102 may be configured to store the third output signal, e.g. in a memory of the processing circuit 102 (e.g., a buffer) and retrieve the stored third output signal during a subsequent processing.

According to various embodiments, the processing circuit 102 may be configured to carry out the reconstruction of the receive signal 108 using the plurality of quantization signals 510-1 . . . 510-N. For example, the processing circuit 102 may be configured to estimate a signal level of a characteristic portion of the receive signal 108 (e.g., a peak or a valley) based on the determined time points 112 and the plurality of quantization signals 510-1 . . . 510-N, e.g. based on which quantization signal(s) is/are at a high level in correspondence of the time point 112 of interest.

As discussed in relation to FIG. 1B and FIG. 1C, comparing the signal level of the detection signal 106 with a threshold level may define a stop signal 126 for the time-of-flight measurement. In the configuration with a plurality of comparators 506-1 . . . 506-N, the processing circuit 102 may be configured to determine the arrival time of the receive signal 108 and generate the corresponding stop signal 126 based on one of the quantization signals 510-1, e.g. the quantization signal 510-1 associated with the smallest threshold level among the quantization signals 510-1 . . . 510-N. Illustratively, the processing circuit 102 may be configured to use as stop signal 126 the output signal of one of the comparators 506-1, e.g. of the comparator receiving the reference signal with the lowest value (e.g., the lowest voltage). The output of this comparator 506-1 turning high may represent the arrival time point of the receive signal 108 (e.g., of its signal component). According to various embodiments, the quantization signal 510-1 used as stop signal 126 may also be provided as control signal to a switching element 404 of the signal differentiation circuit 142 (e.g., to differentiate only relevant portions of the detection signal).

The comparator array may thus perform a comparison of the instantaneous signal level with corresponding reference levels ref₁(t). The reference levels may be either constant or variable in time, e.g. may be increased or decreased with increasing time with respect to the start(t) signal 120. The reference levels may also be adjusted based on timing or other signal properties (amplitude) of previously measured signals, or based on signal properties derived from some form of knowledge about the signal to be expected.

In other embodiments, however, the processing circuit 102 may have a simpler configuration with only one comparator 506-1, whose output signal 510-1 may be used as stop signal 126 (see FIG. 5C). Illustratively, in such configuration, the at least one comparator 508-1 may be used for pulse event detection to create a stop signal 126 for the ToF measurement and trigger the TDC read-out process.

According to various embodiments, the processing circuit 102 may be configured to further process the quantization signals 510-1 . . . 510-N to provide a more sparse representation, which may facilitate the subsequent processing. There may be various options and configurations to generate the sparse representation, in a similar manner as the description in relation to FIG. 2B and FIG. 2C. In general, the processing circuit 102 (e.g., as part of the stop signal generation circuit 502a, 502b) may include an encoding stage 520a, 520b configured to receive the quantization signal(s) 510-1 . . . 510-N and deliver, as output, an encoded sparse signal 522 g(t) providing a sparse and compact representation of the quantization signals 510-1 . . . 510-N.

In various embodiments, the processing circuit 102 (e.g., the stop signal generation circuit 502a, 502b) may be configured to generate a plurality of edge-detection signals 512-1 . . . 512-N d₁(t)-d_{N}(t) (see FIG. 5F). Each edge-detection signal 512-1 . . . 512-N may be associated with a corresponding quantization signal 510-1 . . . 510-N and may be representative of time points at which the corresponding quantization signal 510-1 . . . 510-N has a (rising or falling) edge. Illustratively, each edge-detection signal 512-1 . . . 512-N may representative of time points at which the signal level of the detection signal 106 becomes greater or smaller than the threshold level of the corresponding quantization signal 510-1 . . . 510-N. Such time points may correspond to the signal level of the detection signal 106 going from being less/greater than the threshold level to being greater/less than the threshold level. The edge-detection signals 512-1 . . . 512-N thus encode further information on the waveform of the detection signal 106 (and receive signal 108), so that in some embodiments, the processing circuit 102 may be further configured to carry out the reconstruction of the receive signal 108 using the plurality of edge-detection signals 512-1 . . . 512-N. The processing circuit 102 may be configured to generate the third output signal by encoding the plurality of quantization signals 510-1 . . . 510-N via the plurality of edge-detection signals 512-1 . . . 512-N.

To implement the generation of the edge-detection signals 512-1 . . . 512-N, as shown in FIG. 5A, the encoding stage 520a may include an edge-detection stage 524a. In this configuration, the comparator output signals 510-1 . . . 510-N q₁(t), q₂(t), . . ., q_{N}(t) may each undergo the edge-detection stage 524 a providing the output signals 512-1 . . . 512-N d₁(t), d₂(t), . . . , d_{N}(t). The edge-detection stage 524a may be implemented in various ways and with various levels of accuracy. In a simple configuration the edge-detection stage 524a may include a plurality of simple high-pass filters 526-1 . . . 526-N, e.g. a plurality of low-order RC filters, with an adequately chosen time constant to approximately perform a differentiation of the comparator output signals 510-1 . . . 510-N.

The idea behind performing edge detection is to create a signal 522 that encodes the changes in the comparator output signals and to create a signal that is “sparse” in the sense that most of the time it is in a zero state. Assuming furthermore that the detected signal is continuous with a finite slope, then the edges of the comparator output signals 510-1 . . . 510-N q₁(t), q₂(t), . . ., q_{N}(t) will not temporally coincide, which in turn means that the sparse signals 512-1 . . . 512-N d₁(t), d₂(t), . . . , d_{N}(t) will not be in a non-zero state at the same time.

Based on this observation, the sparse signals 512-1 . . . 512-N d₁(t), d₂(t), . . . , d_{N}(t) may be merged without overlap (i.e. without coinciding non-zero states) into a single signal 522, e.g. by summation, and we obtain the merged signal g(t)=d₁(t)+d₂(t)+ . . . +d_{N}(t), see FIG. 5E. In the configuration in FIG. 5A, the processing circuit 102 may include (as part of the encoding stage 520a) a summation stage 528a configured to merge the edge-detection signals 512-1 . . . 512-N into a single encoded signal 522.

As an alternative approach, as shown in FIG. 5B, the steps of edge-detection and merging may be inverted (see also FIG. 5F). In this configuration, the encoding stage 520b may include a summation stage 528b configured to receive the quantization signals 510-1 . . . 510-N and merge (all of) them together into a summation signal 532. The encoding stage 520b may further include an edge detection stage 530b configured to receive the summation signal 532 and generate an encoded sparse signal 522 by detecting the edges of the summation signal 532 sum(t). In an exemplary configuration, the edge detection stage 530b may be implemented as a differentiator in view of the square-like shape of the summation signal 532.

In both configurations, the encoding stage 520a, 520b may provide, as output, the encoded sparse signal 522, which may provide a compact representation of the waveform of the detection signal 106. The encoded sparse signal 522 may illustratively a plurality of events (a plurality of pulses), each corresponding to a variation of the signal level of the detection signal 106, e.g. from being less than a threshold level 508-1 . . . 508-N to being greater than a threshold level 508-1 . . . 508-N (a positive pulse), or vice versa (a negative pulse). The sequence of events/pulses in the encoded signal 522 may thus allow estimating the behavior over time of the detection signal 106. In various embodiments, the processing circuit 102 may be configured to (further) use the encoded signal 522 for the reconstruction of the receive signal 108.

As shown in FIG. 5E and FIG. 5F, the encoded sparse signal 522 may include pulses with positive or negative polarity, depending on the variation of the detection signal 106. To provide a more convenient representation for digital processing, the processing circuit 102 may be configured, in some embodiments, to generate one or more unipolar representations of the encoded signal (see FIG. 5G).

As an example, in the configuration of FIG. 5A, the processing circuit 102 may include a rectifier stage 534a (a rectifier circuit) configured to receive the encoded signal 522 and deliver, as output, a rectified unipolar signal 536. Illustratively, after summation the sum signal 522 is used to generate the unipolar signal 536 u(t), e.g. by rectification. In another configuration, shown in FIG. 5B), the processing circuit 102 may include a polarity split and rectifier stage 538b configured to receive the encoded signal 522 and deliver, as output, two unipolar signals p(t), n(t) (as output 536b), e.g. one signal p(t) including the positive pulses of the encoded sparse signal 522 and another signal n(t) including the rectified negative pulses of the encoded sparse signal 522.

In an exemplary configuration, the unipolar signal(s) 536, 536b may be delivered as output 540a, 540b of the stop signal generation circuit 502a, 502b encoding information about the shape of the detection signal 106, which the processing circuit 102 may use for reconstructing the receive signal. In other configurations, the encoded sparse signal 522 may itself be delivered as output 540a, 540b, as mentioned above.

The unipolar signal 536 provides a compact and sparse representation that allows a convenient digital processing. Illustratively, as the resulting unipolar signal 536 u(t) has only two states (i.e. a zero state and a non-zero state) it is suitable as input to a subsequent (binary) TDC stage. However, as shown in FIG. 5G, during this processing stage information about the polarity of the non-zero states in the encoded signal 522, and thus the direction of the edge change in the edge-detection signals 512-1 . . . 512-N d₁(t), d₂(t), . . . , d_{N}(t) as well as quantization signals 510-1 . . . 512-0 q₁(t), q₂(t), . . . , q_{N}(t) is lost. Thus, according to various embodiments, the processing circuit 102 may be configured to recover the information about the “polarity” of the changes of signal level encoded in the unipolar signal 536 from the determined time points 112 corresponding to the sign changes of the differentiation signal 110.

Illustratively, the processing circuit 102 may be configured to use, for the reconstruction of the receive signal 108, the unipolar signal 536 in combination with the output 116 of the signal differentiation circuit 142. In a preferred configuration, as shown in FIG. 5G, the processing circuit 102 may be configured to use the unipolar signal 536 in combination with the zero-crossing signal 208. As shown, the information encoded in the zero-crossing signal 208 allows re-obtaining the encoded signal 522 from the unipolar signal 536.

By way of illustration, the zero-crossing signal 208 encodes the zero-crossings of the fist derivative 110 that may be used e.g. to determine the position of the peaks in the detection signal 106 (and detected signal 108). The unipolar signal 536, on the other hand, encodes the sampling points of the detection signal 106. However, as information was lost during the encoding process of the unipolar signal 536, the unipolar signal 536 may provide only a partial and rough reconstruction of the detected signal 108 when used alone. However, using the derivative signal 110 or zero-crossing signal 208, which essentially also represents the direction of the edge transitions, the processing circuit 102 may reconstruct the polarity information in the encoded signal 522 and thus reconstruct the sparse signals 512-1 ... 512-N d₁(t), d₂(t), . . . , d_{N}(t) and the comparator signals 510-1, . . . 510-N q₁(t), q₂(t), . . . , q_{N}(t).

The approach described herein may thus complement and enhance the capabilities of an approach based, only, on a detector with a comparator array that is used for quantifying amplitude information. For many practical applications the exact shape or amplitude progression of the signal is not relevant, but only certain pulse characteristics like peaks or inflection points that may be determined by means of differentiation.

The differentiation-based strategy allows to directly determine the timing of local minima and maxima of the signal by using a pre-processing stage that determines the first derivative used as an input for the signal acquisition via a TDC delay line chain. Equally, the timing of inflection points of the signal may be determined based on the second derivative. This may allow to simplify the signal acquisition setup, e.g. in cases when certain properties of the signal shape are known in advance. Furthermore, it is also possible to combine the comparator array approach (see FIG. 5A and FIG. 5B) with the signal derivative(s) approach to enable a more robust determination of the signal shape, e.g. in case of overlapping double-pulses. In general mathematical terms, to reconstruct a signal shape one may use as many sample points as there are free variables in the mathematical expression describing the signal. These sample points could be either direct instantaneous amplitude values, or special points based on the first and/or second derivate or a combination of both approaches.

In the present disclosure, the additional characteristics may be acquired via an easy to implement analog pre-processing stage based on differentiation, a low-complexity digitization stage using zero-crossing detectors, and signal capturing via a (fine) TDC stage. What is more, capturing the additional signal characteristics may be implemented by a synergetic usage of components, giving rise to cost-effective implementations. Generally speaking, by implementing the adapted method described herein, the acquisition of certain pulse characteristics becomes possible, which may significantly simplify the interpretation or processing of the pulse data if, for example, the expected pulse shape is known. In addition, it is conceivable to sufficiently reconstruct a signal by using a combination of amplitude information and other pulse characteristics. Essentially, by encoding the first derivative, as presented herein, it becomes possible to resort to a more simplified encoding scheme, allowing to reduce the number of processing stages for capturing the detected signal sampling points.

FIG. 6 shows a digital processing circuit 600 in a schematic view, according to various embodiments. The digital processing circuit 600 may be an exemplary configuration of the digital portion 150b of the processing circuit 102, e.g. an exemplary configuration of the time-of-flight determination circuit 144.

According to various embodiments, the digital processing circuit 600 may include a coarse-TDC circuit 602, a fine-TDC circuit 604, a time-of-flight calculation circuit 606, and a signal reconstruction circuit 608.

The coarse-TDC circuit 602, for example, may be implemented counting clock cycles to determine the time-of-flight of a transmit signal (e.g., the transmit signal 122) with a lower granularity. The coarse-TDC circuit 602 may be configured to receive a start signal 610 (start(t), e.g. the start signal 120), a stop signal 612 (stop(t), e.g. the stop signal 126), and a clock signal 614, and may be configured to provide (e.g., generate) a coarse time measurement signal 616 based on the start signal 610, the stop signal 612, and the clock signal 614. For example, the coarse time measurement signal 616 may include a number N of clock cycles between a first rising edge of the start signal 610 and a first rising edge of the stop signal 612. In an exemplary configuration the start signal 610 may be delivered from a higher-level system, e.g. the transmitter of a LIDAR system. In the case of a LIDAR, the start signal 610 may denote the point in time when the light pulse was emitted. Other applications may provide different start signals, depending on the nature and timing of the application.

The fine-TDC circuit 604, for example, may include a tapped delay line to determine the time-of-flight with a finer granularity. In a tapped delay line implementation, the input signal may be fed (serially) into the tapped delay line and, by doing so, it is digitized, stored and made available for parallel readout.

The fine-TDC circuit 604 may be configured to receive the stop signal 612, the clock signal 614, and one or more encoded signals 618, 620. For example, the fine-TDC circuit 604 may be configured to receive a first encoded signal 618 (e.g., the encoded signal 538a, 538b) from a stop signal generation circuit, and/or a second encoded signal 620 (e.g., the output signal 116) from a signal differentiation circuit.

The fine-TDC circuit 604 may be configured to generate a fine time measurement signal 622 based on the stop signal 612, the clock signal 614, and the information encoded in the one or more encoded signals 618, 620, e.g. using time points encoded therein. As an example, the fine time measurement signal 622 may include a number M of elementary time units (with a given time duration) that represent a fine time, and which may be generated based on the time points encoded in the one or more encoded signals 618, 620 and may be used as adjustment values for the coarse time measurement signal 616.

The time-of-flight calculation circuit 606 may be configured to receive the coarse time measurement signal 616 and the fine time measurement signal 622, and to calculate the time-of-flight associated with the transmit signal based on the coarse time measurement signal 616 and the fine time measurement signal 622. The time-of-flight calculation circuit 606 may be configured to generate a (digital) measurement signal 624 representing the determined time-of-flight.

The fine-TDC circuit 604 may further be configured to carry out a time-to-digital conversion of the encoded signal(s) 618, 620 to provide one or more corresponding digitized signals 618d, 620d. The fine-TDC circuit 604 may be configured to deliver the one or more digitized signals 618d, 620d to the signal reconstruction circuit 608, which may be configured to generate a reconstructed signal 626 based on the received digitized signals 618d, 620d which encode information on the properties of a receive signal detected at the detection device. The reconstructed signal 626 may thus be a reconstructed version of the receive signal based on the characteristic properties encoded in the encoded signals 618, 620.

FIG. 7 shows a LIDAR system 700 in a schematic view, according to various embodiments. The LIDAR system 700 may be an exemplary application scenario for the detection device and detection method described herein.

The LIDAR system 700 may include a LIDAR emitter 702 (e.g., an example of the signal emission circuit 100a) and a LIDAR receiver 704 (an example of the signal detection circuit 100b).

The LIDAR emitter 702 may include a laser source 706 and a driver 708 configured to drive laser emission by the laser source 706. The LIDAR system 700 may further include emission optics 710 to direct the laser light towards the field of view of the LIDAR system. The LIDAR emitter 702 may thus emit a laser signal 712 towards the field of view of the LIDAR system 700. The laser signal 712 (an example of transmit signal 122) may hit an object 714 in the field of view and be reflected back towards the LIDAR system 700.

The LIDAR receiver 704 may receive a reflected signal 716 (an example of receive signal 108) corresponding to the back-reflection of the laser signal 712. The LIDAR system 700 may further include receive optics 718 to direct light from the field of view towards the LIDAR receiver.

The LIDAR receiver 704 may include a detector 720 including one or more photo diodes 722 and an amplifier 724 (e.g., a transimpedance amplifier). The detector 720 may be configured to provide a detection signal 726 (an example of detection signal 106) to a processing circuit 728 (an example of processing circuit 102) of the LIDAR emitter 704.

The processing circuit 728 may include an analog signal processing circuit 730a and a digital signal processing circuit 730b.

The analog signal processing circuit 730a may include one or more comparators 732 (e.g., a comparator array) configured to generate a stop signal 734 for the measurement of the time-of-flight of the laser signal 712. Optionally, the analog signal processing circuit 730a may include an encoding circuit 736 configured to encode the output of the comparator(s) 732 and generate an encoded signal 738.

According to the configuration proposed herein, the analog signal processing circuit 730a may include a first differentiation circuit 740 and encoding circuit 742 to generate a first-order derivative of the detection signal 726 and generate a first encoded signal 744 representative of the time points corresponding to sign changes of the first derivative.

Additionally, the processing circuit 730a may include a second differentiation circuit 746 and encoding circuit 748 to generate a second-order derivative of the detection signal 726 and generate a second encoded signal 750 representative of the time points corresponding to sign changes of the second derivative.

The digital processing circuit 730b may include a coarse-TDC circuit 752 and one or more fine-TDC stages 754-1, 754-2, 754-3. The coarse-TDC circuit 752 may be configured to generate a coarse measurement signal 756 based on the stop signal 734 and on a start signal 758 delivered by a measurement control circuit 760 of the LIDAR system 700. The fine-TDC stages 754-1, 754-2, 754-3 may be configured to generate a respective digitized version 762-1, 762-2, 762-3 of the encoded signals from the analog processing circuit 730a for subsequent signal reconstruction and processing.

According to various embodiments, for time-of-flight sensor applications, including LIDAR, certain characteristics of the detected signals may be used to improve the sensor performance or open-up new functionalities. For example, knowing the amplitude of the detected signal allows to draw conclusions about the channel attenuation. This in turn may be used, e.g., to infer the properties of a detected object in a LIDAR application. Similarly, knowing the exact position of the peak in a detected signal helps to improve the precision of the of the Time-of-Flight measurement (i.e. the so-called walk-error may be reduced). Or as another example, knowing that there are several peaks in a detected signal may allow to draw conclusions if the edge of an object was hit by the emitted light pulse.

The approach described herein allows to directly measure certain characteristics of the signal, e.g. the exact timing of the peak(s), adopting a different signal processing chain with respect to conventional configurations. The proposed approach significantly reduces the amount of data processing after the acquisition of the signal, by providing the means to directly capture relevant timing information in the observed signal, e.g. by directly capturing the timing information associated with peaks or inflection points. In a highly simplified approach, no data processing at all may be needed as the captured output from the first and/or second differentiation stage may be sufficient for determining the desired signal characteristic.

The term “amplitude” may be used herein to describe the height of a peak, e.g. the height of a pulse. The term “amplitude” may describe the signal level of the signal at the peak with respect to a reference value for the signal level. The term “amplitude” may be used herein also in relation to a signal that is not a symmetric periodic wave, e.g. also in relation to an asymmetric wave (for example in relation to a signal including periodic pulses in one direction). In this regard, the term “amplitude” may be understood to describe the amplitude of the signal (e.g., of the peak) as measured from the reference value of the signal level.

The term “processor” or “processing circuit” as used herein may be understood as any kind of technological entity that allows handling of data. The data may be handled according to one or more specific functions executed by the processor or processing circuit. Further, a processor or processing circuit as used herein may be understood as any kind of circuit, e.g., any kind of analog or digital circuit. A processor or processing circuit may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor or processing circuit. It is understood that any two (or more) of the processors or processing circuits detailed herein may be realized as a single entity with equivalent functionality or the like, and conversely that any single processor or processing circuit detailed herein may be realized as two (or more) separate entities with equivalent functionality or the like.

The term “calculate” as used herein encompasses both ‘direct’ calculations via a mathematical expression/formula/relationship and ‘indirect’ calculations via lookup or hash tables and other array indexing or searching operations.

The terms “differential”, “differentiate”, and “differentiated” may be used herein as commonly understood in their mathematical sense, to indicate an operation in which a derivative of a function is determined. The terms “differential”, “differentiate”, and “differentiated” may be used herein in relation to the processing of a signal to indicate an operation in which variations in the signal level of the signal (e.g., in its amplitude) over time are determined, e.g. an operation in which variations in the slope of the signal over time are determined.

While various implementations have been particularly shown and described with reference to specific embodiments, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

1.-15. (canceled)

16. A detection device comprising:
a processing circuit configured to:
receive a detection signal representative of a receive signal detected at the detection device, wherein the receive signal is associated with a corresponding predefined transmit signal and/or is associated with one or more expected signal features;
generate a differentiation signal representative of a rate of change of a signal level of the detection signal over time;
determine time points corresponding to a change of a sign of the differentiation signal; and
encode the determined time points to generate an output signal representative of one or more characteristic properties of the receive signal.

17. The detection device according to claim 16, wherein the processing circuit is further configured to:
receive a start signal representative of a starting time point of an emission of the predefined transmit signal;
generate a stop signal representative of an arrival time of the receive signal at the detection device;
calculate a time-of-flight associated with the predefined transmit signal based on the start signal and the stop signal; and
modify a value of the calculated time-of-flight based on the one or more characteristic properties of the receive signal encoded in the output signal.

18. The detection device according to claim 17,
wherein, to calculate the time-of-flight, the processing circuit is configured to carry out a time-to-digital conversion to generate a digital signal representative of a time difference between the start signal and the stop signal.

19. The detection device according to claim 17,
wherein the one or more characteristic properties comprise time locations within the receive signal of one or more peaks and/or one or more valleys of the receive signal in correspondence of the determined time points, and
wherein the processing circuit is configured to modify the value of the calculated time-of-flight based on the time location of a first peak within the receive signal.

20. The detection device according to claim 16, wherein the processing circuit is further configured to:
generate a second differentiation signal representative of a rate of change of a signal level of the differentiation signal over time;
determine second time points corresponding to a change of a sign of the second differentiation signal from positive to negative or from negative to positive; and
encode the determined second time points to generate a second output signal representative of one or more second characteristic properties of the receive signal detected at the detection device.

21. The detection device according to claim 16, wherein the processing circuit comprises an analog differentiation circuit configured to:
receive the detection signal;
carry out an analog differentiation of the detection signal; and
deliver, as output of the analog differentiation, the differentiation signal.

22. The detection device according to claim 16, wherein the one or more characteristic properties of the receive signal comprise a number of peaks in the receive signal, and/or a number of valleys in the receive signal, and/or a time-distance between consecutive peaks in the receive signal, and/or a slope of the receive signal, and/or a time-distance between a reference time point and one or more peaks and/or valleys in the receive signal.

23. The detection device according to claim 16, wherein the processing circuit is further configured to filter the received detection signal prior to generating the differentiation signal and to reduce a noise level in the detection signal.

24. The detection device according to claim 16,
wherein the processing circuit is configured to determine the time points corresponding to a change of a sign of the differentiation signal by determining one or more zero-crossings of the differentiation signal.

25. The detection device according to claim 24,
wherein the processing circuit comprises a zero-crossing detector configured to deliver a zero-crossing output signal at a first signal level in case that the signal level of the differentiation signal is equal to or greater than a predefined threshold value, and to deliver the zero-crossing output signal at a second signal level in case that the signal level of the differentiation signal is less than the predefined threshold value, and
wherein the processing circuit is configured to determine the time points corresponding to a change of a sign of the differentiation signal based on the time points corresponding to the zero-crossing output signal switching from the first signal level to the second signal level, or vice versa.

26. The detection device according to claim 16, wherein the processing circuit is further configured to:
generate the output signal by encoding the determined time points via an encoded sparse signal, and
wherein the encoded sparse signal is at a signal level different from zero in correspondence of the time points corresponding to the change of the sign of the differentiation signal and is at a signal level of substantially zero in the remaining portions of the encoded sparse signal.

27. The detection device according to claim 16,
wherein the processing circuit is further configured to:
generate a plurality of quantization signals,
wherein each quantization signal is associated with a respective threshold level, and
wherein each quantization signal is representative of portions of the detection signal having a signal level within a corresponding range defined by the respective threshold level; and
encode the quantization signals to generate a third output signal representative of one or more third characteristic properties of the receive signal detected at the detection device.

28. The detection device according to claim 27, wherein the processing circuit is further configured to
generate the third output signal by encoding the plurality of quantization signals via a plurality of edge-detection signals,
wherein each edge-detection signal is associated with a respective quantization signal and the corresponding threshold level, and
wherein each edge-detection signal is representative of time points at which the signal level of the detection signal becomes greater than the corresponding threshold level or becomes less than the corresponding threshold level.

29. The detection device according to claim 16,
wherein the transmit signal is an emitted light signal, and
wherein the receive signal is a reflected light signal corresponding to a reflection of the emitted light signal towards the detection device.

30. A time-of-flight detector comprising:
a processing circuit configured to:
receive a start signal representative of a starting time point of an emission of a transmit signal;
receive a detection signal representative of a receive signal detected at the time-of-flight detector, wherein the receive signal comprises a reflection of the transmit signal towards the time-of-flight detector;
generate a stop signal representative of an arrival time of the receive signal at the time-of-flight detector;
carry out a time-to-digital conversion to calculate a time-of-flight associated with the transmit signal based on the start signal and the stop signal;
generate a differentiation signal representative of a rate of change of a signal level of the detection signal over time;
determine time points corresponding to a change of a sign of the differentiation signal; and
modify a value of the calculated time-of-flight based on the determined time points.
